(19) United States
(12) Patent Application Publication
(10) Pub. No.: US 2002/0060780 A1
(43) Pub. Date: May 23, 2002

(54) Projector

(75) Inventors: Takeshi Takezawa, Matsumoto-shi (JP); Toshiaki Hashizume, Okaya-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 09/976,152

(22) Filed: Oct. 15, 2001

(30) Foreign Application Priority Data
Oct. 13, 2000 (JP) 2000-312904
Oct. 12, 2001 (JP) 2001-315861

(51) Int. Cl. G03B 21/18

(52) U.S. Cl. 353/53

(57) ABSTRACT

To provide a projector which, by a simple method, makes it possible to eliminate the chances of incident light directly striking a drive element.

An optical axis FCL of a field lens 400 provided at the light-incident side of a liquid crystal panel 411 is shifted parallel to a center axis FCL0 of light incident thereupon. The optical axis FCL of the field lens is shifted so that the incident angle of light striking the drive element is made small when the center axis FCL0 of the incident light and the optical axis FCL coincide. Therefore, there is no oblique light that strikes the drive element, so that scratching, breakage, and malfunctioning of the drive element do not result, thereby making it possible to increase the quality of a projected image.

### DETAILED DESCRIPTION OF THE INVENTION

1. Technical Field of the Invention

The present invention relates to a projector including an active liquid crystal device.

1. Description of the Related Art

The active liquid crystal device is often used in a projector. Such a liquid crystal device includes, for example, thin-film transistors (TFTs) or diodes as drive elements respectively provided for each pixel, and is used to form an image by modulating incident light in accordance with image information (image signals).

A general projector comprises an illumination optical system including a polarization generation optical system that converts unpolarized light emitted from a light source into predetermined linearly polarized light beams and that causes them to exit therefrom; a color light separation optical system that separates the linearly polarized light beams emitted from the illumination optical system into light beams of three colors, red, green, and blue; three liquid crystal devices that modulate the corresponding color light beams in accordance with image information (image signals); a color light synthesizing optical system comprising a cross dichroic prism that synthesizes each of the modulated color light beams; and a projection optical system which projects the synthesized light beams onto a screen.

FIG. 22 is a perspective view from a light-incident-surface side of a liquid crystal device, with a portion of the liquid crystal device being shown in enlarged form. FIGS. 23 and 24 are sectional views taken along line F-F′ and line G-G′ of FIG. 21, respectively. For simplifying the description, FIGS. 22 to 24 schematically shown only some of the structural elements of the liquid crystal device. The liquid crystal device has a structure in which liquid crystals 5 are filled between a base substrate 1 and a counter substrate 2, which are formed of, for example, glass. A drive element 3, such as a thin-film transistor (TFT) or a diode, is formed on a surface of the base substrate 1 at the side of the liquid crystals 5. A light-shielding mask 6 is formed in matrix form at the liquid crystal device, and open portions 4 are formed in the portions of the liquid crystal device other than the portion where the light-shielding mask 6 is formed.

### Problems To be Solved by the Invention

Since light incident upon the open portions 4 of the liquid crystal device spreads by a certain amount, as shown in FIGS. 23 and 24, there are, in addition to light beams B1 to B4 that are incident upon the open portions 4 in a vertical direction, light beams A1 to A4 and C1 to C4 that are obliquely incident upon the liquid crystal device without being blocked by the light-shielding mask 6. Among the obliquely incident light beams A1 to A4 and C1 to C4, the light beams C1, A2, C3, and A4 that are incident upon the liquid crystal device in a direction away from the drive element 3 are not much of a problem, but the light beams A1, C2, A3, and C4 which move towards the drive element 3 are a problem. As shown in FIGS. 23 and 24, when the light beams A1 and C4 are such as to strike the drive element 3, problems, such as scratching, deterioration, or malfunctioning of the drive element 3, arise, so that the quality of a projected image is deteriorated.

Particularly, in recent years, considerable effort has been put into increasing the aperture ratio of the liquid crystal device. Raising the aperture ratio further increases the chances of the drive element 3 being struck by light.

The present invention has been achieved to overcome such problems, and the object of the present invention is to make it possible to enhance the quality of a projected image by eliminating the chances of a drive element being directly struck by incident light, at a low cost and by using a simple method.

### Means for Solving the Problems

A projector of the present invention comprises a light source; a liquid crystal device which modulates light emitted from the light source; and a projection lens which projects the light modulated by the liquid crystal device; wherein the liquid crystal device comprises a base substrate that has a plurality of pixel electrodes disposed in a matrix arrangement and drive elements each provided for corresponding one of the pixel electrodes and electrically connected thereto, a counter substrate provided with a light-shielding mask which covers at least a portion of the drive elements, and liquid crystals provided between the base substrate and the counter substrate; and wherein the angle of light incident upon the liquid crystal device is restricted not to allow the light to strike the drive elements.

According to the present invention, the angle of the light incident upon the liquid crystal device is restricted not to allow the incident light to strike the drive elements, so that scratching, breakage, and malfunctioning of the drive elements do not occur. Therefore, it is possible to improve the quality of a projected image.

In the projector of the present invention, in the case where a condenser lens is provided at a light-incident side of the liquid crystal device, by shifting a center axis of light incident upon the condenser lens and an optical axis of the condenser lens in parallel so that the incident angle of light that strikes the drive elements becomes small when the center axis of the light incident upon the condenser lens and the optical axis of the condenser lens coincide, the angle of the light incident upon the liquid crystal device can be restricted. When this is achieved, it is possible to easily solve the above-described problems.

Here, when an optical axis of the projection lens is shifted parallel to the center axis of the light incident upon the condenser lens in the same direction as the optical axis of the condenser lens, it is possible to efficiently incorporate the modulated light into the projection lens, so that the efficiency in using light can be increased.

In the projector of the present invention, in the case where a micro-lens array comprising a plurality of lenses corresponding to the pixel electrodes is disposed at a light-incident side of the base substrate, by shifting a center axis of light incident upon the micro-lens array and a center of the micro-lens array so that the incident angle of light that strikes the drive elements becomes small when the center axis of the light incident upon the micro-lens array and the center of the micro-lens array coincide, the angle of the light incident upon the liquid crystal device can be restricted. When this is achieved, it is possible to easily solve the above-described problems.

Here, when the micro-lens array is provided on the counter substrate, it is possible to decrease an interface between the micro-lens array and the counter substrate. Therefore, it is possible to prevent loss of light at this interface, so that the efficiency in using light can be increased.

When an optical axis of the projection lens is shifted parallel to the center axis of the light incident upon the micro-lens array in the same direction as an optical axis of the micro-lens array, it possible to efficiently incorporate the modulated light into the projection lens, so that the efficiency in using light can be increased. It is also possible to prevent distortion of a projected image into a trapezoidal shape.

Further, in the projector of the present invention, by tilting an optical axis of the light source with respect to a normal line of the counter substrate so that the incident angle of light that strikes the drive elements becomes small when the normal line of the counter substrate and the optical axis of the light source are parallel to each other, the angle of the light incident upon the liquid crystal device can be restricted.

Here, when an optical axis of the projection lens is tilted into predetermined linearly polarized light beams and that causes them to exit therefrom; a color light separation optical system that separates the linearly polarized light beams emitted from the illumination optical system into light beams of three colors, red, green, and blue; three liquid crystal devices that modulate the corresponding color light beams in accordance with image information (image signals); a color light synthesizing optical system comprising a cross dichroic prism that synthesizes each of the modulated color light beams; and a projection optical system which projects the synthesized light beams onto a screen.

FIG. 22 is a perspective view from a light-incident-surface side of a liquid crystal device, with a portion of the liquid crystal device being shown in enlarged form. FIGS. 23 and 24 are sectional views taken along line F-F′ and line G-G′ of FIG. 21, respectively. For simplifying the description, FIGS. 22 to 24 schematically shown only some of the structural elements of the liquid crystal device. The liquid crystal device has a structure in which liquid crystals 5 are filled between a base substrate 1 and a counter substrate 2, which are formed of, for example, glass. A drive element 3, such as a thin-film transistor (TFT) or a diode, is formed on a surface of the base substrate 1 at the side of the liquid crystals 5. A light-shielding mask 6 is formed in matrix form at the liquid crystal device, and open portions 4 are formed in the portions of the liquid crystal device other than the portion where the light-shielding mask 6 is formed.

### Problems to be Solved by the Invention

Since light incident upon the open portions 4 of the liquid crystal device spreads by a certain amount, as shown in FIGS. 23 and 24, there are, in addition to light beams B1 to B4 that are incident upon the open portions 4 in a vertical direction, light beams A1 to A4 and C1 to C4 that are obliquely incident upon the liquid crystal-device without being blocked by the light-shielding mask 6. Among the obliquely incident light beams A1 to A4 and C1 to C4, the light beams C1, A2, C3, and A4 that are incident upon the liquid crystal device in a direction away from the drive element 3 are not much of a problem, but the light beams A1, C2, A3, and C4 which move towards the drive element 3 are a problem. As shown in FIGS. 23 and 24, when the light beams A1 and C4 are such as to strike the drive element 3, problems, such as scratching, deterioration, or malfunctioning of the drive element 3, arise, so that the quality of a projected image is deteriorated.

Particularly, in recent years, considerable effort has been put into increasing the aperture ratio of the liquid crystal device. Raising the aperture ratio further increases the chances of the drive element 3 being struck by light.

The present invention has been achieved to overcome such problems, and the object of the present invention is to make it possible to enhance the quality of a projected image by eliminating the chances of a drive element being directly struck by incident light, at a low cost and by using a simple method.

### Means for Solving the Problems

A projector of the present invention comprises a light source; a liquid crystal device which modulates light emitted from the light source; and a projection lens which projects the light modulated by the liquid crystal device; wherein the liquid crystal device comprises a base substrate that has a plurality of pixel electrodes disposed in a matrix arrangement and drive elements each provided for corresponding one of the pixel electrodes and electrically connected thereto, a counter substrate provided with a light-shielding mask which covers at least a portion of the drive elements, and liquid crystals provided between the base substrate and the counter substrate; and wherein the angle of light incident upon the liquid crystal device is restricted not to allow the light to strike the drive elements.

According to the present invention, the angle of the light incident upon the liquid crystal device is restricted not to allow the incident light to strike the drive elements, so that scratching, breakage, and malfunctioning of the drive elements do not occur. Therefore, it is possible to improve the quality of a projected image.

In the projector of the present invention, in the case where a condenser lens is provided at a light-incident side of the liquid crystal device, by shifting a center axis of light incident upon the condenser lens and an optical axis of the condenser lens in parallel so that the incident angle of light that strikes the drive elements becomes small when the center axis of the light incident upon the condenser lens and the optical axis of the condenser lens coincide, the angle of the light incident upon the liquid crystal device can be restricted. When this is achieved, it is possible to easily solve the above-described problems.

Here, when an optical axis of the projection lens is shifted parallel to the center axis of the light incident upon the condenser lens in the same direction as the optical axis of the condenser lens, it is possible to efficiently incorporate the modulated light into the projection lens, so that the efficiency in using light can be increased.

In the projector of the present invention, in the case where a micro-lens array comprising a plurality of lenses corresponding to the pixel electrodes is disposed at a light-incident side of the base substrate, by shifting a center axis of light incident upon the micro-lens array and a center of the micro-lens array so that the incident angle of light that strikes the drive elements becomes small when the center axis of the light incident upon the micro-lens array and the center of the micro-lens array coincide, the angle of the light incident upon the liquid crystal device can be restricted. When this is achieved, it is possible to easily solve the above-described problems.

Here, when the micro-lens array is provided on the counter substrate, it is possible to decrease an interface between the micro-lens array and the counter substrate. Therefore, it is possible to prevent loss of light at this interface, so that the efficiency in using light can be increased.

When an optical axis of the projection lens is shifted parallel to the center axis of the light incident upon the micro-lens array in the same direction as an optical axis of the micro-lens array, it possible to efficiently incorporate the modulated light into the projection lens, so that the efficiency in using light can be increased. It is also possible to prevent distortion of a projected image into a trapezoidal shape.

Further, in the projector of the present invention, by tilting an optical axis of the light source with respect to a normal line of the counter substrate so that the incident angle of light that strikes the drive elements becomes small when the normal line of the counter substrate and the optical axis of the light source are parallel to each other, the angle of the light incident upon the liquid crystal device can be restricted.

Here, when an optical axis of the projection lens is tilted parallel to the normal line of the counter substrate in the same direction as the optical axis of the light source, it possible to efficiently incorporate the modulated light into the projection lens, so that the efficiency in using light can be increased.

Here, a micro-lens array comprising a plurality of lenses corresponding to the pixel electrodes may be disposed at a light-incident side of the base substrate. In this way, in the case where micro-lenses are provided, when the optical axis of each micro-lens is shifted parallel to the center of each individual pixel of the liquid crystal device towards the light source, it is possible to prevent the incident light from being intercepted by the light-shielding mask, so that a reduction in the brightness of a projected image can be decreased. In addition, when the micro-lens array is provided on the counter substrate, it is possible to decrease an interface between the micro-lens array and the counter substrate. Therefore, it is possible to prevent loss of light at this interfaces so that the efficiency in using light can be further increased.

Further, in the projector of the present invention, it is preferred that a center axis of the light incident upon the liquid crystal device coincide with a distinct-vision direction of the liquid crystal device. When the center axis of the light incident upon the liquid crystal device does not coincide with the distinct-vision direction of the liquid crystal device, it is preferable to cause the center axis of the light that is incident upon or that exits from the liquid crystal device to coincide with the distinct-vision direction of the liquid crystal device by providing a viewing angle compensating film at the light-incident side or the light-exiting side of the liquid crystal device. When such structures are used, it is possible to increase contrast of a projected image and to further improve the quality of the projected image.

When viewing angle compensating films are provided at both the light-incident side and the light-exiting side of the liquid crystal device, the dependency of the liquid crystal device on the viewing angle is reduced, thereby making it possible to increase the brightness and the uniformity of the color tone of a projected image.

It is preferred that the liquid crystal device used in the projector of the present invention include a thin-film transistor as a drive element. In this case, a scanning line and a data line crossing and situated above the scanning line on the base substrate are provided at the base substrate. In addition, the drive elements are connected to the data line and the scanning line, and include channel areas and semiconductor layers situated below the scanning line on the substrate.

The projector of the present invention may be used as a projector which can provide a color display provided with a color light separation optical system which separates the light emitted from the light source into light beams of a plurality of colors between the light source and the liquid crystal device. When the projector of the present invention is used as such a projector which can provide a color display, it is possible to provide a clear color image.

When such a projector with a color light separation optical system is used, it is preferred that a plurality of liquid crystal devices be provided in correspondence with the plurality of color light beams. When a plurality of liquid crystal devices are provided, it is possible to further increase resolution, so that a clearer, higher quality color image can be provided.

### DESCRIPTION OF THE EMBODIMENTS

Hereunder, embodiments of the present invention are described with reference to the drawings. In the description below, unless otherwise specified, the direction of travel of light is defined as the z direction, and, as viewed from the z direction, the twelve o'clock direction is defined as the y direction and the three o'clock direction is defined as the x direction.

A. Optical Systems of Projector

First, an embodiment of a projector is shown in FIG. 1. FIG. 1 is a plan view schematically showing the optical systems of this projector.

A projector 100 of an embodiment includes three main portions as optical systems, a light source-device 20, an image forming optical system 30, and a projection lens 40. Liquid crystal light valves 410R, 410G, and 410B comprise, respectively, liquid crystal panels 411R, 411G, and 411B as liquid crystal devices; light-incident-side polarizers 412R, 412G, and 412B disposed at the light-incident-surface sides of the corresponding liquid crystal panels 411R, 411G, and 411B; and light-exiting-side polarizers 413R, 413G, and 413B disposed at the light-exiting-surface sides of the corresponding liquid crystal panels 411R, 411G, and 411B. In addition, the red-light liquid crystal light valve 410R and the blue-light liquid crystal light valve 410B, and not the green-light liquid crystal light valve 410G, include λ/2 retardation plates 414R and 414B, respectively, at the light-exiting sides thereof. In the description below, the liquid crystal light valves 410R, 410G, and 410B are sometimes generally referred to as “the liquid crystal light valves 410,” the liquid crystal panels 411R, 411G, and 411B generally as “the liquid crystal panels 411,” the light-incident-side polarizes 412R, 412G, and 412B generally as “the polarizers 412,” and the light-exiting-side polarizers 413R, 413G, and 413B generally as “the polarizers 413.”

The image forming optical system 30 comprises an integrator optical system 300; a color light separation optical system 380 including dichroic mirrors 382 and 386, and a reflective mirror 384; and a relay optical system 390 including a light-incident-side lens 392, a relay lens 396, and reflective mirrors 394 and 398, all of which are described later. The image forming optical system 30 also comprises three field lenses 400R, 400G, and 400B as condenser lenses, the three liquid crystal light valves 410R, 410G, and 410B, and a cross dichroic prism 420 serving as a color light synthesizing optical system. In the description below, the field lenses 400R, 400G, and 400B are sometimes generally called “the field lenses 400.”

The light source device 20 is disposed at the light-incident-surface side of a first lens array 320 of the image forming optical system 30. A projection lens 40 including a plurality of lenses at the inside thereof has a zoom mechanism, and is disposed at the light-exiting-surface side of the cross dichroic prism 420 of the image forming optical system 30.

FIG. 2 illustrates an illumination optical system that illuminates the three liquid crystal panels serving as illumination areas of the projector shown in FIG. 1. The illumination optical system comprises a light source 200, provided at the light source device 20, and the integrator optical system 300, provided at the image forming optical system 30. The integrator optical system 300 comprises the first lens array 320, a second lens array 340, a light-shielding plate 350, a polarization conversion element array 360, and a superposition lens 370.

For simplifying the description, FIG. 2 shows only the main structural elements for describing the functions of the illumination optical system.

The light source 200 comprises a light source lamp 210 and a concave mirror 212. Radial light that has exited from the light source lamp 210 is reflected by the concave mirror 212 and exits towards the first lens array 320 as light beams that are substantially parallel to the optical axis of the light source.

Here, a halogen lamp, a metal halide lamp, or a high-pressure mercury lamp may be used as the light source lamp 210, a parabolic mirror or an ellipsoidal mirror is preferably used as the concave mirror 212. When an ellipsoidal mirror is used, a collimating lens is disposed at the light-exiting side of the concave mirror 212.

FIGS. 3(A) and 3(B) are a front view and a side view of the external appearance of the first lens array 320, respectively. The first lens array 320 has small lenses 321 which have rectangular contours and which are disposed in a matrix arrangement of N×2 columns (here N=4) in the y direction and M rows (here, M=10) in the x direction. The external shape of each small lens 321 viewed in the z direction is set so as to be substantially the same as the shape of each of the liquid crystal panels 411R, 411G, and 411B. For example, if the aspect ratio (the ratio of the horizontal and vertical dimensions) of the image formation area of each liquid crystal panel is 4 to 3, the aspect ratio of each small lens 321 is also set at 4 to 3. Such a first lens array 320 functions to divide the substantially parallel light beams that have exited from the light source lamp 210 into a plurality of partial light beams and to cause them to exit therefrom.

The second lens array 340 functions to guide the plurality of partial light beams that have exited from the first lens array 320 so that they are gathered on polarization separation films 366 of two polarization conversion element arrays 361 and 362, and comprises small lenses 341, with the number of which is the same as the number of lenses making up the first lens array 320. The orientation of the lenses of the first lens array 320 and the lenses of the second lens array 340 may be in either the +z direction or the −z direction. As shown in FIG. 2, they may face different directions.

The polarization conversion element array 360 forms a polarization generation optical system that generates linearly polarized light beams in order to efficiently use unpolarized illumination light. Here, as shown in FIG. 2, the two polarization conversion element arrays 361 and 362 are disposed so as to have symmetric orientations, with the optical axis being disposed therebetween. However, one polarization conversion element array having the same orientation may be used. FIG. 4 is a perspective view of the external appearance of one of the polarization conversion element arrays, the polarization conversion element array 361. The polarization conversion element array 361 comprises a polarization beam splitter array 363, which includes a plurality of polarization beam splitters, and λ/2 retardation plates 364 (λ represents the wavelength of light), which are selectively disposed on portions of the light-exiting surface of the polarization beam splitter array 363. The polarization beam splitter array 363 has a shape formed by successively bonding a plurality of columnar light-transmissive members 365 that are parallelogrammic in cross section. The polarization separation films 366 and reflective films 367 are alternately formed on interfaces between the light-transmissive members 365. The λ/2 retardation plates 364 are selectively bonded to image portions in the x direction of the light-exiting surfaces of the polarization separation films 366 or the reflective films 367. In this embodiment, the λ/2 retardation plates 364 are bonded to the image portions in the x direction of the light-exiting surfaces of the polarization separation films 366. Dielectric multilayer films are used for the polarization separation films 366, and dielectric multilayer films or metallic films are used for the reflective films 367.

The polarization conversion element array 361 functions to convert light beams that are incident thereupon into one type of linearly polarized light beams (for example, s-polarized light beams or p-polarized light beams) and to cause them to exit therefrom. FIG. 5 is a schematic view illustrating the operation of the polarization conversion element array 361. When unpolarized light including an s-polarized component and a p-polarized component is incident upon the light-incident surface of the polarization conversion element array 361, the incident light is first separated into an s-polarized light beam and a p-polarized light beam by its corresponding polarization separation film 366. The s-polarized light beam is reflected substantially vertically by each polarization separation film 366, further reflected by its corresponding reflective film 367, and then exits therefrom. On the other hand, the p-polarized light beam passes as it is through its corresponding polarization separation film 366. The λ/2 retardation plates 364 are disposed on surfaces from which the p-polarized light beams transmitted through the corresponding polarization separation films 366 exit, so that the p-polarized light beams are converted into s-polarized light beams, which exit from the corresponding λ/2 retardation plates 364. Therefore, most of the light that has passed through the polarization conversion element array 361 becomes s-polarized light beams, which exit therefrom. When one wants to convert the light that exits from the polarization conversion element array 361 into p-polarized light beams, the λ/2 retardation plates 364 are disposed on the surface from which s-polarized light beams reflected by the corresponding reflective films 367 exit. As long as the polarization directions can be made the same, λ/4 retardation plates may be used, or desired retardation plates may be provided on the surface from which p-polarized light beams exit and the surface from which s-polarized light beams exit.

In the polarization conversion element array 361, one block including one polarization separation film 366 and one reflective film 367 which are adjacent to each other and one λ/2 retardation plate 364 can be considered as one polarization conversion element 368. The polarization conversion element array 361 has such polarization conversion elements 368 disposed in a plurality of columns in the x direction.

The structure of the polarization conversion element array 362 is exactly the same as that of the polarization conversion element array 361, and thus the description thereof is omitted.

As shown in FIG. 2, the light-shielding plate 350 is disposed on the light-incident-surface side of the polarization conversion element array 360, and functions to adjust the amount of light incident upon the polarization separation films 366 from the first lens array 320. Therefore, light-shielding portions 351 and open portions 352 are disposed in a stripe-like arrangement. In other words, the light-shielding plate 350 is a plate-shaped member that is formed by alternately forming, in correspondence with the light-incident surface of each light-transmissive member 365 of the polarization conversion element array 360 (361, 362), the open portions 352, which pass light, and the light-shielding portions 351, which have about the same widths as the light-incident surfaces of the light-transmissive members 356. The light-shielding portions 351 and the open portions 352 are disposed so that the partial light beams emitted from the first lens array 320 are incident only upon the polarization separation films 366 of the polarization conversion element 360, and not upon the reflective films 367.

As described above, the plurality of partial light beams that have exited from the first lens array 320 are each separated into two partial light beams by the polarization conversion element array 360, and the separated partial light beams are converted into substantially one type of linearly polarized light beams (s-polarized light beams and s-polarized light beams or p-polarized light beams and p-polarized light beams), each having the same wavelength phases, by the corresponding λ/2 retardation plates 364. Such plurality of partial light beams that are formed by one type of linearly polarized light beams are superimposed on the illumination areas of the corresponding liquid crystal light valves 410 by the superimposing lens 370 shown in FIG. 2. At this time, the distribution of the intensity of light that illuminates the illumination areas is substantially uniform.

The illumination optical system constructed in the above-described way causes illumination light that possesses the same polarization directions (such as s-polarized light beams and s-polarized light beams) to exit therefrom, and illuminates each of the liquid crystal panels 411R, 411G, and 411B through the color light separation optical system 380 and the relay optical system 390.

The color light separation optical system 380 in the image forming optical system 30 comprises the two dichroic mirrors 382 and 386 and the reflective mirror 384, and functions to separate the light beams emitted from the illumination optical system into light beams of three colors, red (R), green (G), and blue (B). The first dichroic mirror 382 passes the red light component of the light emitted from the illumination optical system, and reflects the blue light component and the green light component. The red light beams R that have passed through the first dichroic mirror 382 are reflected by the reflective mirror 384, and exit in the direction of the cross dichroic prism 420. The red light beams R that have been reflected by the reflective mirror 384 further pass through the field lens (condenser lens) 400R and reach the liquid crystal light valve 410R for red light. The field lens 400R converts each of the partial light beams emitted from the first lens array 320 of the illumination optical system into light beams that are parallel to a center axis thereof. This similarly applies to the field lenses (condenser lenses) 400G and 400B that are provided at the light-incident-surface sides of the liquid crystal light valves 410G and 410B, respectively.

Among the green light beams G and the blue light beams B that have been reflected by the first dichroic mirror 382, the green light beams G are reflected by the second dichroic mirror 386 and exit in the direction of the cross dichroic prism 420. The green light beams G that have been reflected by the second dichroic mirror 386 further pass through the field lens 400G, and reach the liquid crystal light valve 410G for green light. On the other hand, the blue light beams B that have passed through the second dichroic mirror 386 exit from the color light separation optical system 380, and are incident upon the relay optical system 390.

The blue light beams B incident upon the relay optical system 390 reach the liquid crystal light valve 410B for blue light through the light-incident-side lens 392, the reflective mirror 394, the relay lens 396, the reflective mirror 398, and the field lens 400B of the relay optical system 390. The relay optical system 390 is used for the blue light beams B because the path of the blue light beams B is longer than the paths of the other color light beams R and G and is provided to prevent a reduction in the efficiency of using the light is used caused by, for example, light diffusion. In other words, it is provided to transmit the partial light beams incident upon the light-incident-side lens 392 as they are to the field lens 400B.

The color light beams which, as described above, have been separated by the color light separation optical system 380 and which have impinged upon the three liquid crystal light valves 410R, 410G, and 410B, respectively, are modulated in accordance with provided image information (image signals) in order to generate images of the corresponding color light beams.

First, the red-light liquid crystal light valve 410R will be described. The liquid crystal light valve 410R includes the liquid crystal panel 411R, the light-incident-side polarizer 412R, the light-exiting-side polarizer 413R, and the λ/2 retardation plate 414R. The light-incident-side polarizer 412R and the light-exiting-side polarizer 413R are each bonded to glass substrates (not shown), respectively. The polarization axis of the light-incident-side polarizer 412R and the polarization axis of the light-exiting-side polarizer 413R are disposed perpendicular to each other. Therefore, the light-incident-side polarizer 412R is a polarizer that passes s-polarized light beams, while the light-exiting-side polarizer 413R is a polarizer that passes p-polarized light beams.

The s-polarized red light beams R that are incident upon the liquid crystal light valve 410R pass through the corresponding glass substrate (not shown) and the light-incident-side polarizer 412R, bonded to the corresponding glass substrate, virtually as they are, and are incident upon the liquid crystal panel 411R. The liquid crystal panel 411R converts some of the s-polarized light beams that have impinged thereupon into p-polarized light beams. By the light-exiting-side polarizer 413R disposed at the light-exiting-surface side, only the p-polarized light beams pass via the corresponding glass substrate (not shown). The p-polarized light beams that have passed through the light-exiting-side polarizer 413R and the corresponding glass substrate are incident upon the λ/2 retardation 414R, where they are converted into s-polarized light beamsand then exit in the direction of the cross dichroic prism 420.

The green-light liquid crystal light valve 410G includes the liquid crystal panel 411G, the light-incident-side polarizer 412G, and the light-exiting-side polarizer 413G. The light-incident-side polarizer 412G and light-exiting-side polarizer 413G are bonded to glass substrates (not shown), respectively. The light-incident-side polarizer 412G and the light-exiting-side polarizer 413G are disposed so that their polarization axes are perpendicular to each other.

The s-polarized green light beams G that are incident upon the liquid crystal light valve 410G pass through the corresponding glass substrate (not shown) and the light-incident-side polarizer 412G virtually as they are, and are incident upon the liquid crystal panel 411G. The liquid crystal panel 411G converts some of the s-polarized light beams that have impinged thereupon into p-polarized light beams. By the light-exiting-side polarizer 413G, disposed at the light-exiting-surface side, only the p-polarized light beams pass via the corresponding glass substrate (not shown). The p-polarized light beams exit as they are in the direction of the dichroic prism 420.

The blue-light liquid crystal light valve 410B has a structure similar to the red-light liquid crystal light valve 410R. It includes the liquid crystal panel 411B, the light—incident-side polarizer 412B, the light-exiting-side polarizer 413B, and the λ/2 retardation plate 414B. The operation of the liquid crystal light valve 410B is similar to the operation in the case for red light, and thus the description thereof is omitted.

The cross dichroic prism 420 synthesizes the modulated color light beams of the three colors (modulated light beams), which have been transmitted through the liquid crystal light valves 410R, 410G, and 410B, in order to generate synthesized light that represents a color image. In the cross dichroic prism 420, a red light reflective film 421 and a blue light reflective film 422 are formed into a substantially X shape at interfaces of four right-angle prisms. The red light reflective film 421 is formed by a dielectric multilayer film that selects and reflects red light, whereas the blue light reflective film 422 is formed by a dielectric multilayer film that selects and reflects blue light. The color light beams of the three colors are synthesized by the red light reflective film 421 and the blue light reflective film 422 in order to generate synthesized light that represents a color image.

The two reflective films 421 and 422, which are formed at the cross dichroic prism 420, are capable of reflecting s-polarized light beams better than p-polarized light beams, but are capable of transmitting p-polarized light beams better than s-polarized light beams. Therefore, the light beams to be reflected by the two reflective films 421 and 422 are s-polarized light beams, whereas the light beams to be transmitted through the two reflective films 421 and 422 are p-polarized light beams. This is to increase the efficiency in using light at the cross dichroic prism 420. Thus, one λ/2 retardation plate is inserted at least for the red light and the blue light. They may be provided either in front of or behind (that is, the light-incident side or the light-exiting side) their corresponding liquid crystal light valves. They may also be used, being bonded to the polarizers.

The synthesized light that has been generated by the cross dichroic prism 420 exits in the direction of the projection lens 40. The projection lens 40 projects in enlarged form the synthesized light that has exited from the cross dichroic prism 420 in order to display a color image on a screen (not shown).

B. Structure of Liquid Crystal Panels

Next, an example of a structure of each of the liquid crystal panels 411R, 411G, and 411B will be given with reference to FIGS. 6 to 10.

FIG. 6 is a plan view of the base substrate 510 of a liquid crystal panel 411 and each of the structural elements formed thereon, as viewed from the side of the corresponding counter substrate 520. FIG. 7 is a sectional view taken along line H-H′ of FIG. 6.

As shown in FIG. 7, the liquid crystal panel 411 includes the base substrate 510, which is a light-exiting-side substrate, and the counter substrate 520, which is a light-incident-side substrate. The base substrate 510 and the counter substrate 520 are bonded together by a sealant 552. Liquid crystals 550 are sealed in the space surrounded by the base substrate 510, the counter substrate 520, and the sealant 552. The base substrate 510 is, for example, a quartz substrate, a glass substrate, or a silicon substrate, and the counter substrate 520 is, for example, a glass substrate or a quartz substrate. The liquid crystals 550 are, for example, liquid crystals in which one type or several types of nematic liquid crystals are mixed. When an electric field is not applied to the liquid crystals 550 from pixel electrodes 59a described in detail later, the liquid crystals 550 take a predetermined orientation state by alignment films 516 and 522. The sealant 552 is, for example, an adhesive containing photocurable resin or thermosetting resin. Gap materials, such as glass fiber or glass beads, are mixed in the sealant 552 in order to cause the distance between both substrates to be a predetermined value.

As shown in FIG. 6, the sealant 552 is provided on the base substrate 510 along the edges thereof, and a third light-shielding film 553, serving as a frame for defining the periphery of an image display area, is provided parallel to the sealant 552 at the inside of the sealant 552. The third light-shielding film 553 is formed of, for example, a metal, an alloy, or a metal silicide containing, for example, at least one of Ti, Cr, W, Ta, Mo, and Pb, which are opaque, high-melting metals.

At the area at the outer side of the sealant 552, a data line drive circuit 501 which drives data lines 56a by supplying image signals to the data lines 56a at a predetermined timing and an external circuit connection terminal 502 are provided along one side of the base substrate 510. Scanning line drive circuits 504 which drive scanning lines 53a by supplying scanning signals to the scanning lines 53a at a predetermined timing are provided along two sides adjacent to this one side. If a delay of the scanning signals supplied to the scanning lines 53a does not cause any problems, it is obvious that only one of the scanning line drive circuits 504 may be disposed. Data line drive circuits 501 may be disposed on both sides along sides of the image display area. Further, a plurality of wirings 505 for connecting the scanning line drive circuits 504 on both sides of the image display area are provided on the remaining one side of the base substrate 510. Upper and lower conductive materials 506 for achieving electrical conduction between the base substrate 510 and the counter substrate 520 are provided at least at one location of each corner of the counter substrate 520. In addition to the data line drive circuit 501, the scanning line drive circuits 504, etc., there may be provided on the base substrate 510, for example, a sampling circuit which applies image signals to the plurality of data lines 56a at a predetermined timing, a pre-charge circuit which supplies to the plurality of data lines 56a a pre-charge signal of a predetermined voltage prior to the supplying of the image signals, or an inspection circuit for inspecting, for example, the quality of and the presence of defects in the electro-optical device during production and shipment thereof.

Instead of being provided on the base substrate 510, the data line drive circuit 501 and the scanning line drive circuits 504 may be electrically and mechanically connected to, for example, a drive LSI, mounted to a TAB (tape automated bonding) substrate, through an anisotropic conductive film provided at a peripheral portion of the base substrate 510.

The area situated inwardly of the third light-shielding film 553 is the image display area. FIG. 8 shows equivalent circuits of, for example, the wirings and various elements that make up the image display area of the liquid crystal panel 411. The plurality of pixel electrodes 59a is provided in a matrix arrangement at the image display area of the liquid crystal panel 411. With each pixel electrode 59a, a TFT 530, which is a drive element for controlling its corresponding pixel electrode 59a, is formed. The data lines 56a to which image signals S1, S2, . . . , and Sn are supplied are electrically connected to the sources of the corresponding TFTs 530. The scanning lines 53a are electrically connected to the gates of the corresponding TFTs 530, and are constructed so that scanning signals G1, G2, . . . , and Gm are applied to the corresponding scanning lines 53a. The pixel electrodes 59a are electrically connected to the drains of the corresponding TFTs 530. By closing the switches of the TFTs 530 just for a fixed period of time, the image signals S1, S2, . . . , and Sn supplied from the data lines 56a can be written at a predetermined timing. The image signals S1, S2, . . . , and Sn of a predetermined level written onto the liquid crystals 550 (FIGS. 7 and 10) through the pixel electrodes 59a are held between a counter electrode 521 (FIGS. 7 and 10), formed at the counter substrate 520 (FIGS. 7 and 10), for a fixed period of time. When the orientation and order of the molecular association are changed in accordance with the applied voltage level, the liquid crystals 550 (FIGS. 7 and 10) modulate the light in order to make it possible to provide a grayshade display. Here, in order to prevent leakage of the held image signals, storage capacitors 570 are provided in parallel with liquid crystal capacitances formed between the pixel electrodes 59a and the counter electrode 521 (FIGS. 7 and 10).

FIG. 9 is a plan view of plurality of adjacent pixel groups on the base substrate 510 having the data lines, the scanning lines, the pixel electrodes, etc., formed thereon; and FIG. 10 is a sectional view taken along line I-I′ of FIG. 9. In FIG. 10, in order to show each layer and each member in recognizable sizes in the figure, each layer and each member are drawn in different scales.

As shown in FIGS. 9 and 10, the pixel electrodes 59a (whose contours are represented by dotted portions 59a), which are transparent and disposed in a matrix arrangement, are provided on the base substrate 510. The pixel electrodes 59a are formed of, for example, transparent conductive thin films, such as ITO (indium tin oxide) films.

The data lines 56a, the scanning lines 53a, and capacitive lines 53b are provided along the horizontal and vertical boundaries of the pixel electrodes 59a. In the embodiment, the data lines 56a are formed of light-shielding and conductive thin films, such as low-resistance metallic films, which maybe aluminum, and alloy films, which maybe metallic silicide films.

Contact holes 55 which lead to heavily doped source areas 51d and first contact holes 58a which lead to heavily doped drain areas 5le are each formed in a first interlayer insulating film 581 provided on the scanning lines 53a and the capacitive lines 53b. The capacitive lines 53b are formed so as to avoid and surround the first contact holes 58a, at the areas where they cross the data lines 56a and where the first contact holes 58a are formed. In other words, the capacitive lines 53b are formed so as not to be in electrical contact with the first contact holes 58a.

A first barrier layer 580 connected to the heavily doped drain areas 51e through the first contact holes 58a and a second barrier layer 585 connected to the capacitive lines 53b through contact holes 518a are formed on the first interlayer insulating film 581. The second barrier layer 585 is formed of the same type of film as the first barrier layer 580 and is placed upon portions of the capacitive lines 53b that extend along the data lines 56a. The second barrier layer 585 and the capacitive lines 53b are electrically connected through the contact holes 518a. The first barrier 580 and the second barrier layer 585 are specifically formed of a metal, an alloy, or metallic silicide, containing, for example, at least one of Ti, Cr, W, Ta, Mo, and Pb, which are opaque, high-melting metals. When they are formed of such materials, the high-melting metals do not corrode even when they come into contact with the ITO films forming the pixel electrodes 59a, so that good electrical connection can be realized between the first barrier layer 580 and the pixel electrodes 59a. However, the first barrier layer 580 and the second barrier layer 585 may be formed of conductive polysilicon films. Even in this case, the function that increases the storage capacitors 570 and a relay function can be satisfactorily exhibited. In this case, in particular, stress caused by, for example, heat between them and the first interlayer insulating film 581 is not easily generated, so that they are useful for preventing cracking.

A second interlayer insulating film 54 is formed on the first barrier layer 580 and the second barrier layer 585, and the data lines 56a are formed thereon.

Further, a third interlayer insulating film 57 provided with a second contact hole 58b leading to the first barrier layer 580 is formed on the data lines 56a and the second interlayer insulating film 54. The pixel electrodes 59a are provided on the top surface of the third interlayer insulating film 57 having such a structure.

An alignment film 516 that has been subjected to a predetermined alignment operation, such as rubbing, is provided at the side closest to the liquid crystals on the base substrate 510. The alignment film 516 is formed of, for example, an organic thin film, such as a polyimide thin film.

On the base substrate 510, the TFTs 530 where the scanning lines 53a are disposed so as to oppose channel areas 51a′ are formed at locations where the scanning lines 53a and the data lines 56a cross each other, respectively. Each TFT 530 includes the corresponding scanning line 53a that forms a gate electrode, the corresponding channel area 51a′ of a semiconductor layer 51a having a channel formed by an electrical field from the corresponding scanning line 53a, an insulating thin film 52 that insulates the corresponding scanning line 53a and the corresponding semiconductor layer 51a from each other, the corresponding data line 56a forming a source electrode, a lightly doped source area 51b and a lightly doped drain area 51c of the corresponding semiconductor layer 51a, and the heavily doped source area 51d and the heavily doped drain area 51e of the corresponding semiconductor layer 51a. Each semiconductor layer 51a is formed of, for example, a polysilicon film. The channel areas 51a′ are disposed in correspondence with the areas where the scanning lines 53a and the data lines 56a cross each other. The heavily doped source area 51d, the lightly doped source area 51b, the channel area 51a′, the lightly doped drain area 51c, and the heavily doped drain area 51e of each semiconductor layer 51a are disposed so as to overlap and to be covered by each data line 56a. Each heavily doped source area 51d and each lightly doped source area 51b are disposed below each data line 56a which extends towards one side, and each lightly doped drain area 51c and each heavily doped drain area 51e are disposed below each data line 56a that extends towards the other side, with each scanning line 53a being disposed therebetween. Each heavily doped drain area 51e is connected to its corresponding pixel electrode 59a through its corresponding first contact hole 58a and the first barrier layer 580. On the other hand, each heavily doped source area 51d is electrically connected to its corresponding data line 56a through its corresponding third contact hole 55. In the liquid crystal panels 411R, 411G, and 411B used in the embodiment, by forming the first contact holes 58a and the third contact holes 55 so that they overlap the data lines 56a, which are non-display areas, it is possible to prevent the aperture ratio from being reduced by these contact holes, and to prevent the production of irregular unevenness in an open area of each pixel by the presence of these contact holes. Further, disposing portions of the semiconductor layers 51a in a way to overlap the data lines 56a allows the data lines 56a to be used as portions of a light-shielding mask which prevents entry of incident light into the TFTs 530 from the side of the counter substrate 520.

As shown in FIGS. 9 and 10, the storage capacitors 570 are formed on the base substrate 510. Each storage capacitor 570 comprises the corresponding capacitive line 53b serving as a second capacitive electrode, the corresponding insulating thin film 52, and a first capacitive electrode 51f disposed so as to oppose the corresponding capacitive line 53b through the corresponding insulating thin film 52. The storage capacitors 570 are also formed by the capacitive lines 53b, the first interlayer insulating film 581, and a portion of the first barrier layer 580 disposed so as to oppose the capacitive lines 53b through the first interlayer insulating film. Accordingly, since the storage capacitors 570 are formed not only below the capacitive lines 53b, but also above the capacitive lines 53b, large storage capacitors 570 can be formed by effectively using a limited area. The capacitive lines 53b are formed of conductive polysilicon films that are the same as those used to form the scanning lines 53a. The first capacitive electrodes 51f are provided so as to extend from the drain areas 51e of the semiconductor layers 51a. Among constant potential sources, such as a negative power supply and a positive power supply for peripheral circuits (such as, the scanning line drive circuits and the data line drive circuit) used to drive the liquid crystal panel, a ground power supply, and a constant potential supply for a counter electrode, an optimal constant potential is supplied to the capacitive lines 53b, so that stable storage capacitors 570 can be constructed between the first capacitive electrodes 51f and the barrier layer 580.

Further, as shown in FIG. 10, first light-shielding films 511 are disposed between the base substrate 51 and the TFTs 530, at locations opposing the corresponding TFTs 530. More specifically, as shown in FIG. 9, the first light-shielding films 511 are each formed in a band shape along the scanning lines 53a, and the portions thereof that cross the data lines 56a are formed with wide widths at the lower side in FIG. 10. By the wide width portions, the first light-shielding films 511 are formed at locations where they cover each of the TFT channel areas 51a′ and its adjacent area, as viewed from the side of the base substrate. The first light-shielding films 511 are provided to prevent light, such as reflected light from the side of the base substrate 510, from impinging upon the channel areas 51a′, the lightly doped source areas 51b, and the lightly doped drain areas 51c of the TFTs 530 which tend to be exited by light, so that changes in the characteristics of the TFTs 530 resulting from leak currents caused by the light are prevented from occurring. Preferably, the first light-shielding films 511 are formed of, for example, a metal, an alloy, or a metal silicide containing, for example, at least one of Ti (titanium), Cr (chromium), W (tungsten), Ta (tantalum), Mo (molybdenum), and Pb (lead), which are opaque, high-melting metals. Among constant potential sources, such as a negative power supply and a positive power supply for peripheral circuits (such as, the scanning line drive circuits and the data line drive circuit) used to drive the liquid crystal panel, a ground electrical supply, and a constant potential supply for a counter electrode, the first light-shielding films 511 are electrically connected to an optimal constant potential. In this way, by fixing the first light-shielding films 511 at a constant potential, it is possible to prevent malfunctioning of the TFTs 530.

Further, an underlying insulating film 512 is provided between the first light-shielding films 511 and the plurality of TFTs 530. The underlying insulating film 512 is provided to electrically insulate the semiconductor layers 51a of the TFTs 530 from the first light-shielding films 511. By forming the underlying insulating film 512 throughout the entire surface of the base substrate 510, it functions as an underlying film for the TFTs 530. In other words, it functions to prevent deterioration of the characteristics of the TFTs 530 caused by roughness at the time of polishing the surface of the base substrate 510 or dirt remaining after cleaning it. The underlying insulating film 512 is formed of, for example, highly insulative glass, such as NSG (no-dopant silicate glass), PSG (phosphosilicate glass), BSG (borosilicate glass), or BPSG (borophosphosilicate glass), a silicon oxide film, or a silicon nitride film. By the underlying insulating film 512, it is also possible to previously prevent the first light-shielding films 511 from contaminating, for example, the TFTs 530.

Micro-lenses may also be formed on the counter substrate 520 so that one micro-lens is provided for one pixel or one micro-lens is provided for a plurality of pixels. When micro-lenses are formed, incident light can be gathered at the inside of the open portions, thereby making it possible to make the projected image bright.

On the other hand, the counter electrode 521 is provided throughout the entire surface of the counter substrate 520. The alignment film 522, which has been subjected to a predetermined alignment operation, such as a rubbing operation, is provided below the counter electrode 521. The counter electrode 521 is formed of, for example, a transparent conductive thin film such as an ITO film. The alignment film 522 is formed of an organic thin film, such as a polyimide thin film.

Further, as shown in FIG. 10, a second light-shielding film 523 forming part of a light-shielding mask is provided at the counter substrate 520. By the second light-shielding film 523 and the previously described data lines 56a, the incident light from the side of the counter substrate 520 is prevented from entering the TFTs 530. The second light-shielding film. 523 also functions to increase contrast ratio. The second light-shielding film 523, just as the first light-shielding films 511, is formed of, for example, a metal, an alloy, or metal silicide containing, for example, at least one of Ti, Cr, W, Ta, Mo, and Pb, which are opaque, high-melting metals.

Although each TFT 530 preferably has an LDD structure, each TFT 530 may have an offset structure in which impurities are not driven into the lightly doped source areas 51b and the lightly doped drain areas 51c. Each TFT may be a self-aligning type in which a high concentration of impurities is driven into the gate electrodes, which form part of their corresponding scanning lines 53a, used as a mask, in order to form their corresponding heavily doped source areas 51d and their corresponding heavily doped drain areas 51e by self alignment.

In the embodiment, although there is used a single-gate structure in which only one gate electrode, formed by part of its corresponding scanning line 53a of each TFT 530, is disposed between its corresponding heavily doped source area 51d and its corresponding heavily doped drain area 51e, two or more gate electrodes may be disposed therebetween. Accordingly, when the TFTs are each formed using two gates or three or more gates, it is possible to prevent leakage current at the junctions of the channels, the sources, and the drains, so that electrical current during an off state can be reduced. If at least one of these gate electrodes is formed with an LDD structure or an offset structure, it is possible to further decrease off-state electrical current, so that a stable switching element can be obtained.

In addition, in the embodiment, although staggered-type and co-planar type polysilicon TFTs have been taken as an example, other types of TFTs, such as inverted staggered TFTs or amorphous silicon TFTs, may also be used.

C. Restriction of Angle of Light Incident Upon Liquid Crystal Panels

In the projector of the embodiment, as shown in FIGS. 11(A) and 11(B), by shifting an optical axis FCL of a field lens 400, which is a condenser lens provided at the light-incident side of its corresponding liquid crystal panel 411, parallel to a center axis FCL0 of the light incident upon the field lens, the angle of the light incident upon the liquid crystal panel 411 is restricted. The optical axis FCL of the field lens 400 is shifted so that the angle of incidence of the light striking the TFTs 530 becomes small when the center axis FCL0 of the light incident upon the field lens 400 and the optical axis FCL of the field lens 400 coincide.

This state will be described with FIGS. 12(A) and 12(B). FIGS. 12(A) and 12(B) are sectional views corresponding to the above-described FIG. 22 and FIG. 23, respectively. A light-shielding mask 6 is formed by combining light-shielding-mask functioning portions of the second light-shielding film 523 (FIG. 10), formed on the counter substrate 520, and light-shielding-mask functioning portions of the data line 56a, formed on the base substrate 510. For simplifying the description, it is illustrated on the counter substrate 520.

Here, when the center axis FCL0 of the light incident upon the field lens 400 and the optical axis FCL of the field lens 400 coincide, the state is assumed as being as shown in FIGS. 22 and 23. When, as in the embodiment, the optical axis FCL of the field lens 400 is shifted, the light beams A1 to A4, B1 to B4, and C1 to C4 shown in FIG. 22 and FIG. 23 are incident upon the field lens 400 at angles like those of light beams A1′ to A4′, B1′ to B4′, and C1′ to C4′ shown in FIGS. 12(A) and 12(B). As can been seen from comparison between these figures, in the projector of the embodiment, by shifting the optical axis FCL of the field lens 400, incident angles α1 and α2 of the light beams A1 and C4 (shown by dotted lines in FIGS. 12(A) and 23(B)) that strike the TFTs 530 are made small when the center axis FCL0 of the light incident upon the field lens 400 and the optical axis FCL of the field lens 400 coincide. As a result, the light beams A1 and C4 are incident thereupon at angles ⊕1 and β2 like those of the light beams A1′ and C4′ (β1<α1 and β2<α2), so that they do not strike the TFTs 530.

In this way, in the projector of the embodiment, by shifting the center axis FCLO and the optical axis FCL parallel to each other so that the incident angles α1 and α2 of the light beams A1 and C4 that strike the TFTs 530 become small when the center axis FCL0 of the light incident upon the field lens 400 and the optical axis FCL of the field lens 400 coincide, the angle of the light incident upon the corresponding liquid crystal panel 411 is restricted. With such a structure, oblique light does not strike the TFTs 530, so that scratching, breakage, and malfunctioning of the TFTs 530 do not occur.

As shown in FIG. 11(B), when an optical axis OCL of the projection lens 40 is shifted parallel to the center axis FCLO of the incident light in the same direction as the optical axis FCL of the field lens 400, the efficiency in using light can be increased. This is because, when the optical axis FCL of the field lens 400 is shifted, the light which is modulated by the liquid crystal panel 411 and moves towards the projection lens 40 is tilted towards the optical axis FCL. By shifting the optical axis OCL of the projection lens 40 in the same direction as the optical axis FCL of the field lens 400, the modulated light can be efficiently incorporated into the projection lens 40.

D. Second Embodiment

With FIGS. 13, 14(A), and 14(B), a second embodiment of the present invention will be described. In the embodiment, a micro-lens array 526 is provided at the light-incident side of each liquid crystal panel 411. Unlike in the previously described first embodiment where the optical axis of each field lens 400 is shifted, in this embodiment, as shown in FIG. 13, a center axis FCL0 of light incident upon each micro-lens array and a center MCL of each micro-lens array are shifted in order to restrict the angle of the light incident upon each of the liquid crystal panels 411. The other points are the same as those of the first embodiment. Component parts that are the same as those used in the first embodiment will not be described in detail or illustrated in the figures. In FIGS. 13, 14(A), and 14(B), the corresponding parts to those used in the previously described first embodiment will be given the same reference numerals.

FIG. 13 illustrates the relationship between the center axis FCLO of the incident light, the center MCL of a micro-lens array 526, and an optical axis OCL of the projection lens 40 in the second embodiment; and FIGS. 14(A) and 14(B) are sectional views corresponding to the previously described FIGS. 12(A) and 22. FIG. 14(A) shows the embodiment (in which the center axis FCLO of the light incident upon the micro-lens array 526 and the center MCL of the micro-lens 526 are shifted), and FIG. 14(B) shows a comparative example (in which the center axis FCL0 of the light incident upon the micro-lens array 526 and the center MCL of the micro-lens 526 coincide).

In the embodiment, as shown in FIGS. 13 and 14(A), the micro-lens array 526 having a plurality of micro-lenses 527 is provided at the light-incident side of the corresponding liquid crystal panel 411. As shown in FIG. 14(A), the micro-lens array 526 is bonded to the incident side of its corresponding counter substrate 520 by an adhesive 525. In other words, the micro-lens array 526 is provided on its corresponding counter substrate 520.

As shown in FIG. 13, the center MCL of the micro-lens array 526 is shifted with respect to the center axis FCLO of the incident light. This state is described in more detail using FIGS. 14(A) and 14(B). As shown in FIG. 14(B), when the center axis FCLO of the light incident upon the micro-lens array 526 and the center NCL of he micro-lens array 526 coincide, there are light beams A which strike the TFTs 530. In this embodiment, the center MCL of the micro-lens array 526 is shifted so that incident angle α of the light beams A is made small. This causes the light beams A to be incident thereupon at an angle β (<α) like that of light beams A′ shown in FIG. 14(A).

Accordingly, in the projector of the embodiment, by shifting the center axis FCL0 and the center MCL of the corresponding micro-lens array 526 so that the incident angles α1 and α2 of the light beams A1 and A2 that strike the TFTs 350 become small when the center axis FCL0 of the light incident upon the corresponding micro-lens array 526 and the center MCL of the corresponding micro-lens array 526 coincide, the angle of the light incident upon the corresponding liquid crystal panel 411 is restricted. Even with such a structure, it is possible to obtain the same advantages as those of the first embodiment described earlier.

Further, as shown in FIG. 13, when the optical axis OCL of the projection lens 40 is shifted parallel to the center axis FCLO of the incident light in the same direction as the center MCL of the micro-lens array 526, it is possible to increase the efficiency in using light. This is because, when the center MCL of the micro-lens array 526 is shifted, the light which is modulated by the corresponding liquid crystal panel 411 and then moves towards the projection lens 40 tilts towards the center MCL, so that, by shifting the optical axis OCL of the projection lens 40 in the same direction as the center MCL of the micro-lens array 526, the modulated light can be efficiently incorporated into the projection lens 40. However, it is not necessary to shift the optical axis OCL of the projection lens 40 in this manner.

E. Third Embodiment

Referring to FIGS. 15, 16(A), and 16(B), a third embodiment of the present invention will be described. Unlike in the previously described first embodiment where the optical axis of each field lens 400 is shifted, in this embodiment, an optical axis OA of the light source 200 is tilted towards a normal line HCL0 of each counter substrate 520 of its corresponding liquid crystal panel 411 in order to restrict the angle of the light incident upon each of the liquid crystal panels 411. The other points are the same as those of the first embodiment. Component parts that are the same as those used in the first embodiment will not be described in detail or illustrated in the figures. In FIGS. 15, 16(A), and 16(B), the parts corresponding to those used in the previously described first embodiment will be given the same reference numerals.

FIG. 15 shows the relationship between the normal line HCL0 of a counter substrate 520, the optical axis OA of the light source 200, and the optical axis OCL of the projection lens 40 in the third embodiment; and FIGS. 16(A) and 16(B) are sectional views corresponding to the previously described FIGS. 22 and 23.

Here, when the optical axis OA of the light source 200 is parallel to the normal line HCL0 of the counter substrate 520, the state is assumed as being as shown in FIGS. 22 and 23. As in the embodiment, when the optical axis OA of the light source is tilted with respect to the normal line HCL0, the light beams A1 to A4, B1 to B4, and C1 to C4 become incident thereupon at angles like those of light beams A1′ to A4′, B1′ to B4′, and C1′ to C4′ shown in FIGS. 16(A) and 16(B). As can be seen by comparing these figures, in the projector of the embodiment, by tilting the optical axis OA of the light source 200 with respect to the normal line HCL0, incident angles α1 and α2 of the light beams A1 and C4 (represented by dotted lines in FIGS. 16(A) and 16(B)) that strike the TFTs 530 are made small when the optical axis OA of the light source 200 is parallel to the normal line HCL0 of the corresponding counter substrate 520. As a result, the light beams A1 and C4 are incident thereupon at angles β1 and β2 (β1<α1 and β2<α2) like the light beams A1′ and C4′, so that they do not strike the TFTs 530.

Accordingly, in the projector of the embodiment, by tilting the optical axis OA of the light source 200 with respect to the normal line HCL0 of the corresponding counter substrate 520 so that the incident angles α1 and α2 of the light beams A1 and A2 that strike the TFTs 350 become small when the optical axis OA of the light source 200 is parallel to the normal line HCL0 of the corresponding counter substrate 520, the angle of the light incident upon the corresponding liquid crystal panel 411 is restricted. Even with such a structure, it is possible to obtain the same advantages as those of the previously described first embodiment.

Further, as shown in FIG. 15, when the optical axis OCL of the projection lens 40 is shifted parallel to the normal line HCL0 of the counter substrate 520 in the same direction as the optical axis OA of the light source 200, it is possible to increase the efficiency in using light. This is because, by tilting the optical axis OA of the light source 200, the light which is modulated by the corresponding liquid crystal panel 411 and then moves towards the projection lens 40 is tilted, so that, when the optical axis OCL of the projection lens 40 is shifted in the same direction as the optical axis OA of the light source 200, the modulated light can be efficiently incorporated into the projection lens 40. In addition, when it is shifted parallel to the normal line HCL0 of the corresponding counter substrate 520, it is possible to prevent distortion of a projected image into a trapezoidal shape. However, it is not necessary to shift the optical axis OCL of the projection lens 40 in this manner.

Further, in the embodiment, a micro-lens array 526 having a plurality of micro-lenses 527 may be provided at the light-incident side of each liquid crystal panel 411. FIGS. 17(A) and 17(B) are sectional views showing the example in which the micro-lens array 526 is provided at the light-incident side of a liquid crystal panel 411, and correspond to the previously described FIG. 12(A). As shown in FIGS. 17(A) and 17(B), the micro-lens array 526 is bonded to the light-incident side of the corresponding counter substrate 520 with an adhesive. In other words, the micro-lens array 526 is provided on the corresponding counter substrate 520. Accordingly, even when the micro-lens array 526 is provided at the light-incident side of the corresponding liquid crystal panel 411, it is possible to obtain the above-described advantages. However, when, as shown in FIG. 17(A), an optical axis MCLO of each micro-lens 527 and a center PCL of each pixel PX coincide, a portion (cross-hatched portion in the figure) of the incident light may be intercepted by the light-shielding mask 6. Accordingly, when a portion of the incident light is intercepted, a projected image may become dark. To overcome this, as shown in FIG. 17(B), when the optical axis MCLO of each micro-lens 527 is shifted parallel to the center PCL of each pixel PX towards the light source 200, it is possible to prevent the incident light from being intercepted so that a reduction in the brightness of a projected image can be reduced.

F. Fourth Embodiment

In each of the above-described embodiments, it is preferred that the center axis FCLO (corresponding to the optical axis OA of the light source 200 in the case of the third embodiment) of the light incident upon or emitted from each of the liquid crystal panels 411 coincide with the distinct-vision direction of each of the liquid crystal light valves 410. This is because this makes it possible to provide, in addition to the advantages of each of the above-described embodiments, the advantage of increasing contrast that is provided by the liquid crystal light valves 410, so that contrast of a projected image can be increased. Here, when it is difficult to cause the distinct-vision direction of the liquid crystal light valves 410 and the center axis FCL0 to coincide, it is effective to use a viewing angle compensating film (not shown). The viewing angle compensating film may be provided either at the light-incident side or the light-exiting side of each liquid crystal panel 411. However, it is necessary to dispose t between each light-incident-side polarizer 412 and its corresponding liquid crystal panel 411 or between each light-exiting-side polarizer 413 and its corresponding liquid crystal panel 411. The viewing angle compensating film may be bonded to either its corresponding polarizer 412 or its corresponding polarizer 413 or to its corresponding counter substrate 520 or its corresponding base substrate 510.

In order to illustrate the advantages provided by the use of the viewing angle compensating film, the viewing angle characteristics of the liquid crystal light valves 410 based on simulation results are illustrated in FIGS. 18 to 20. Each of these figures shows the viewing angle characteristics when a normally white mode voltage (in the case where light is shut out when voltage is applied, and light is transmitted when voltage is not applied) is applied in a TN mode (twisted nematic mode). In addition, each of the top diagrams shows the brightness distribution at a black level in the liquid crystal light valves 410, whereas each of the bottom diagrams shows the relationship between the brightness and angle in the vertical and horizontal directions.

FIG. 18 illustrates the viewing angle characteristics in the case where the viewing angle compensating film is not used, that is, the viewing angle characteristics of a comparative example. FIG. 18 shows that the brightness changes excessively with changes in the angles of the incident light in the vertical and horizontal directions, and that the brightness distribution is not balanced.

On the other hand, FIG. 19 illustrates the viewing angle characteristics in the case where the viewing angle compensating film is disposed at the light-incident side of each liquid crystal panel 411. Since, by the viewing angle compensating film, the center axis FCL0 (corresponding to the optical axis OA of the light source 200 in the case of the third embodiment) of the light that is incident upon each liquid crystal panel 411 is caused to coincide with the distinct-vision direction of each liquid crystal light valve 410, the brightness in the horizontal direction does not depend upon the angle of the incident light. In addition, the brightness distribution is uniform in the horizontal direction.

FIG. 20 illustrates the viewing angle characteristics in the case where the viewing angle compensating film is disposed at the light-exiting side of each liquid crystal panel 411. In this case, in contrast to the case shown in FIG. 19, the brightness in the vertical direction does not depend on the angle of the incident light, and the brightness distribution is uniform in the vertical direction.

G. Fifth Embodiment

In each of the above-described embodiments, a viewing angle compensating film may be disposed at the light-incident side and the light-exiting side of each liquid crystal panel 411. This is because, in addition to the advantages provided by each of the above-described embodiments, this provides the advantage of reduced dependency of the liquid crystal light valves 410 on the viewing angle, so that the brightness and the uniformity of the color tone of a projected image can be increased. Here, the viewing angle compensating films must be disposed between each light-incident-side polarizer 412 and its corresponding liquid crystal panel 411 and between each light-exiting-side polarizer 413 and its corresponding liquid crystal panel 411. The viewing angle compensating films may be bonded to the polarizers 412 and 413 or to the corresponding counter substrates 520 and corresponding the base substrates 510.

FIG. 21 illustrates the viewing angle characteristics in the case wherein viewing angle compensating films are each disposed at the light-incident side and the light-exiting side of each liquid crystal panel 411. In this case, compared to the comparative example shown in FIG. 18, the brightness in both the vertical and horizontal directions virtually does not depend upon the angle of the incident light. The brightness distribution is well balanced and is generally uniform.

H. Other Forms

The present invention is not limited to the above-described embodiments and forms, so that it can be carried out in various modes within a scope not departing from the gist of the invention. For example, modifications such as those set forth below are possible.

For example, although in the above-described embodiments TFTs 530 are used as drive elements, drive elements formed by thin-film diodes may also be used in place of the TFTs 530.

Although in the embodiments only a projector using three liquid crystal devices has been given as an example, the present invention may be applied to a projector using only one, two, or four or more liquid crystal devices.

Although the above-described embodiments are described using the case where the present invention is applied to a projector using transmissive liquid crystal panels, the present invention may also be applied to a projector using reflective liquid crystal panels. Here, “transmissive” refers to a type of liquid crystal panel that transmits light, whereas “reflective” refers to a type of liquid crystal panel that reflects light.

In a projector using a reflective liquid crystal panel or reflective liquid crystal panels, the dichroic prism may be used as color light separating means that separates light into light beams of the three colors, red, green, and blue, and as color light synthesizing means that synthesizes the modulated light beams of the three different colors and causes them to exit therefrom in the same direction.

Available as a projector area front projector which performs a projection operation from the direction of observation of a projected image, and a rear projector which performs a projection operation from a side opposite to the direction of observation of a projected image. The present invention is applicable to both of these types of projectors.

[Advantages]

As described above, according to the present invention, since the angle of the light incident upon the liquid crystal devices is restricted so that the light does not strike the drive elements, it is possible to prevent scratching, breakage, and malfunctioning of the drive elements. Therefore, the quality of a projected image can be increased.

### BRIEF DESCRIPTION OF THE DRAWINGS

FIG. 1 is a plan view of the optical systems of a projector of the present invention.

FIG. 2 illustrates an illumination optical'system of the optical systems shown in FIG. 1.

FIGS. 3(A) and 3(B) are, respectively, a front view and a side view of a first lens array of the illumination optical system.

FIG. 4 is a perspective view of the external appearance of a polarization conversion element array.

FIG. 5 is a schematic view illustrating the operation of the polarization conversion element array.

FIG. 6 is a plan view of a base substrate of a liquid crystal panel, as viewed from the side of a counter substrate.

FIG. 7 is a sectional view taken along line H-H′ of FIG. 6.

FIG. 8 shows equivalent circuits of, for example, the wirings and various elements that make up an image display area of the liquid crystal panel used in the embodiment.

FIG. 9 is a plan view of a plurality of pixel groups on the base substrate of the liquid crystal panel used in the embodiment of the present invention.

FIG. 10 is a sectional view taken along line I-I′ of FIG. 9.

FIGS. 11(A) and 11(B) are plan views of a first embodiment of the present invention.

FIGS. 12(A) and 12(B) are sectional views used to illustrate the advantages of the first embodiment of the present invention.

FIG. 13 is a plan view of a second embodiment of the present invention.

FIG. 14(A) is a sectional view used to illustrate the advantages of the second embodiment of the present invention.

FIG. 14(B) is a sectional view used to illustrate a comparative example.

FIG. 15 is a plan view of a third embodiment of the present invention.

FIGS. 16(A) and 16(B) are sectional views used to illustrate the advantages of the second embodiment of the present invention.

FIGS. 17(A) and 17(B) are sectional views used to illustrate the advantages of the second embodiment of the present invention.

FIG. 18 shows the viewing characteristics of each of the liquid crystal light valves when a viewing angle compensating film is not used.

FIG. 19 shows the viewing angle characteristics of each of the liquid crystal light valves when a viewing angle compensating film is disposed at the light-incident side of each liquid crystal light valve.

FIG. 20 shows the viewing angle characteristics of each of the liquid crystal light valves when a viewing angle compensating film is disposed at the light-exiting side of each liquid crystal light valve.

FIG. 21 shows the viewing angle characteristics of each liquid crystal light valve when viewing angle compensating films are disposed at the light-incident side and the light-exiting side of each liquid crystal light valve.

FIG. 22 is a perspective view of a conventional liquid crystal device, viewed from its light-incident-surface side.

FIG. 23 is an enlarged sectional view taken along line F-F′ of FIG. 6.

FIG. 24 is an enlarged sectional view taken along line G-G′ of FIG. 6.

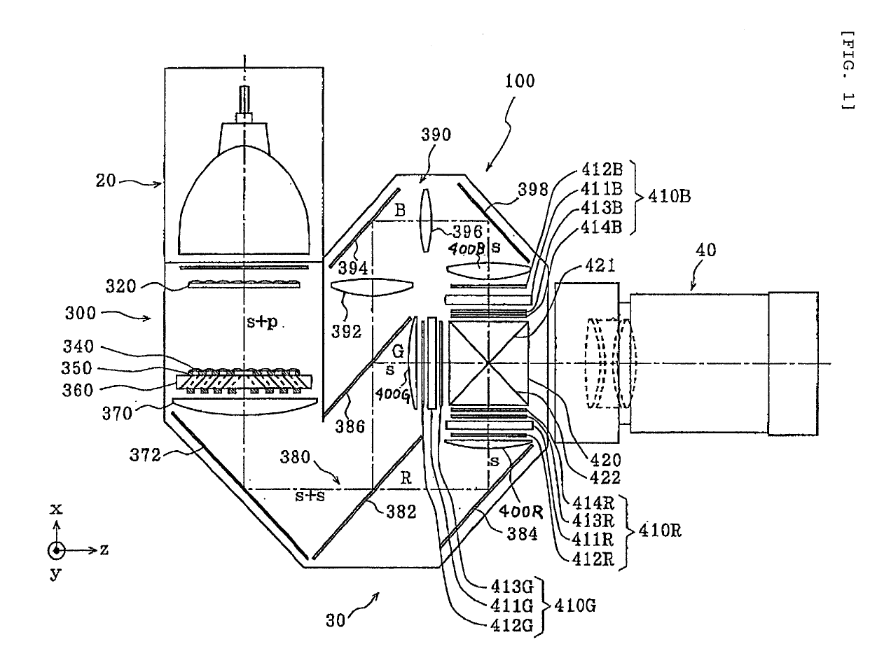

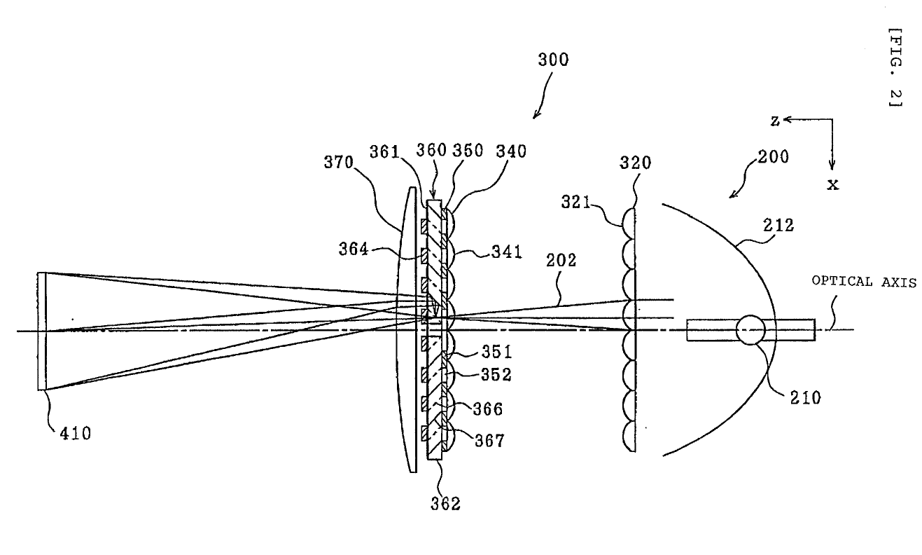

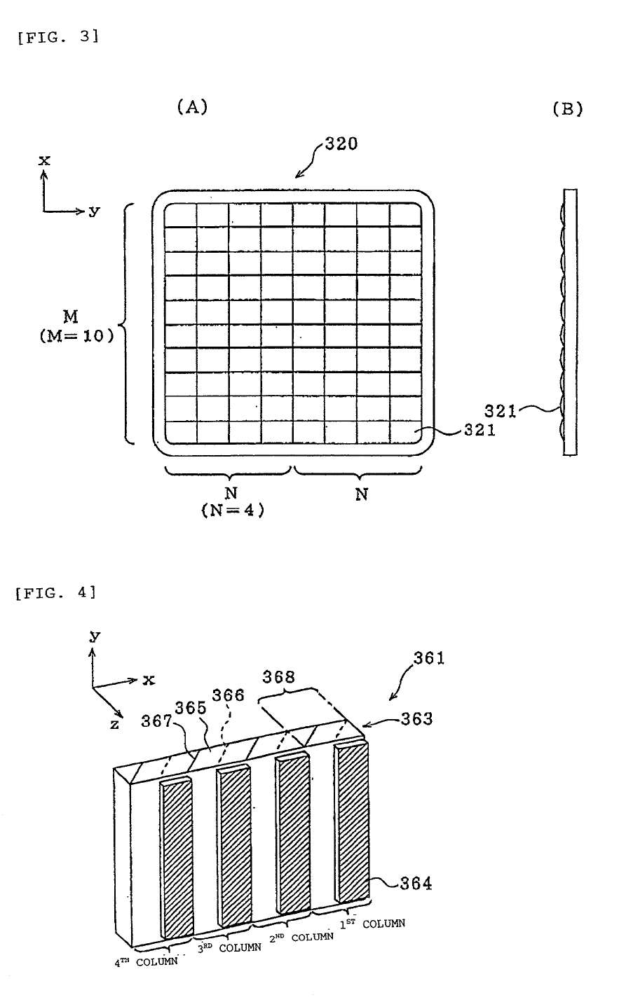

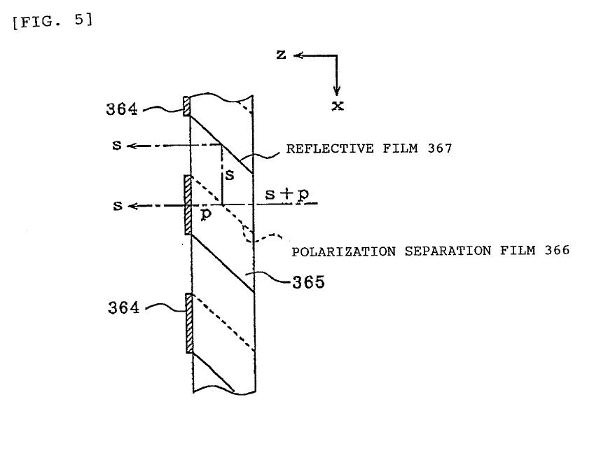

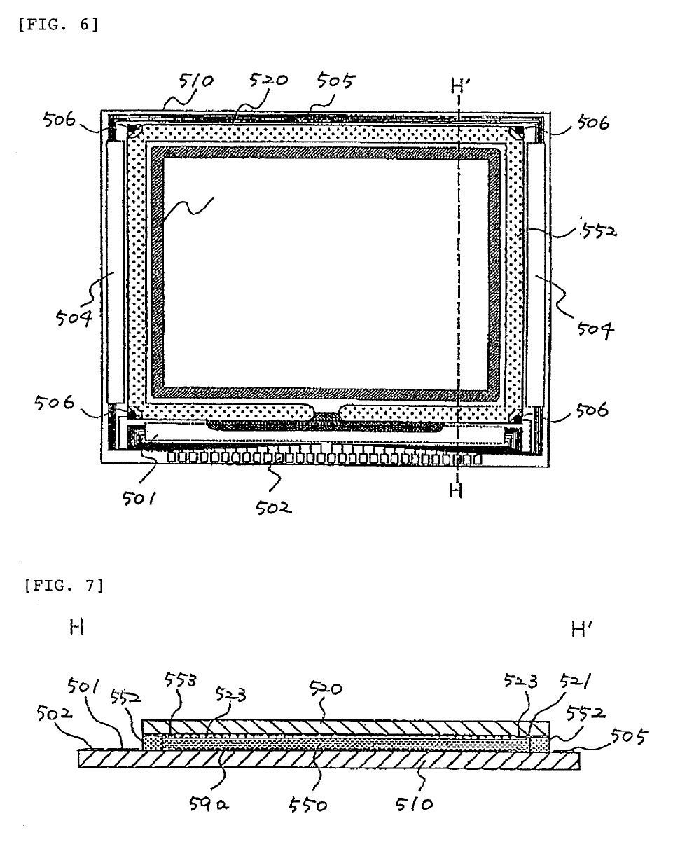

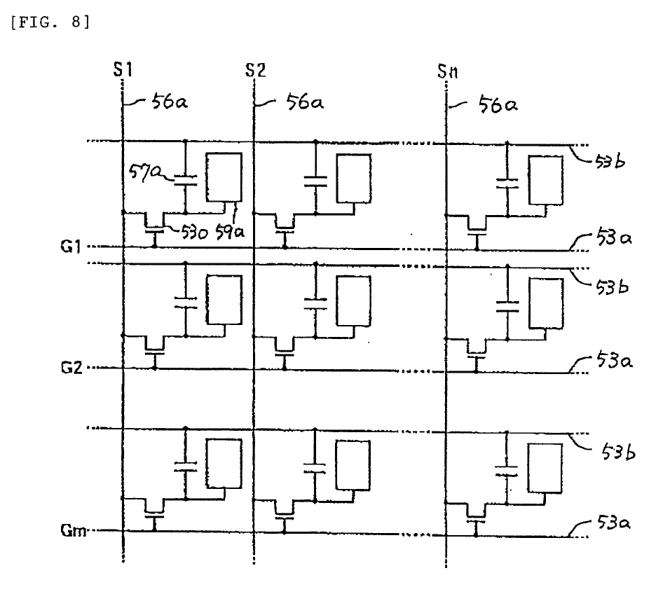

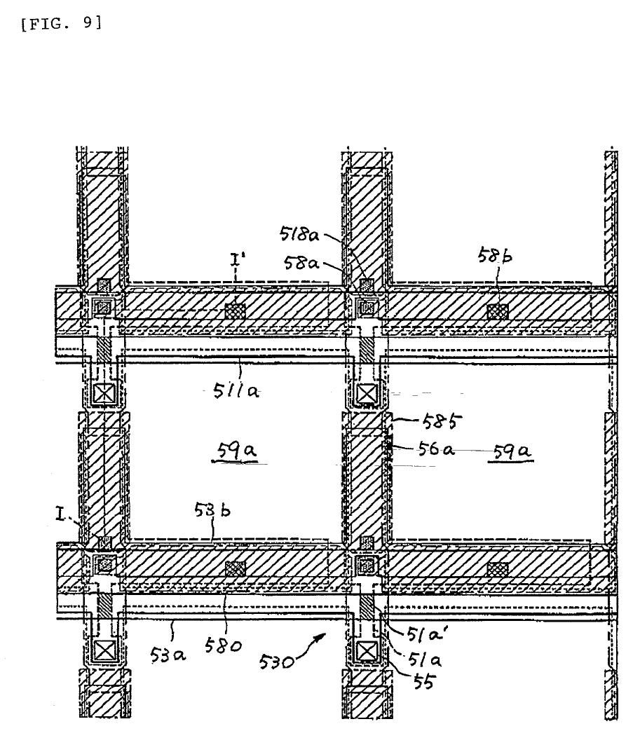

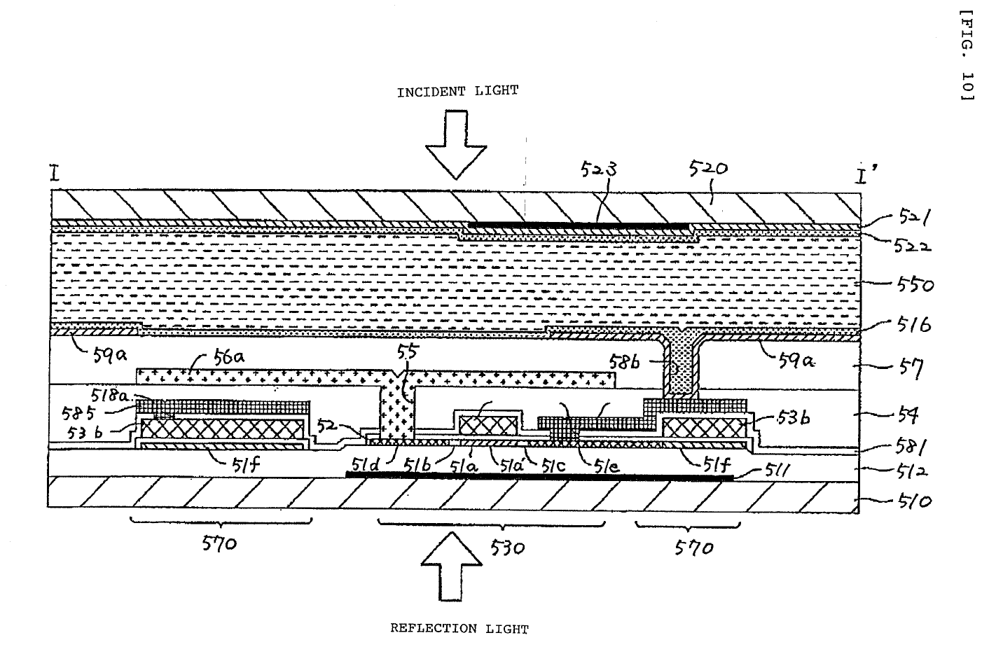

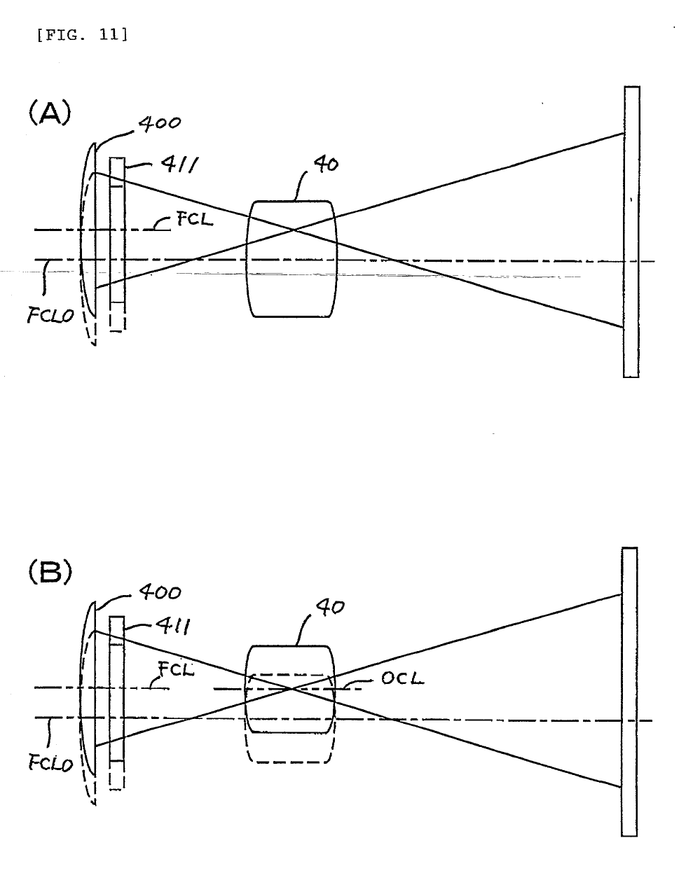

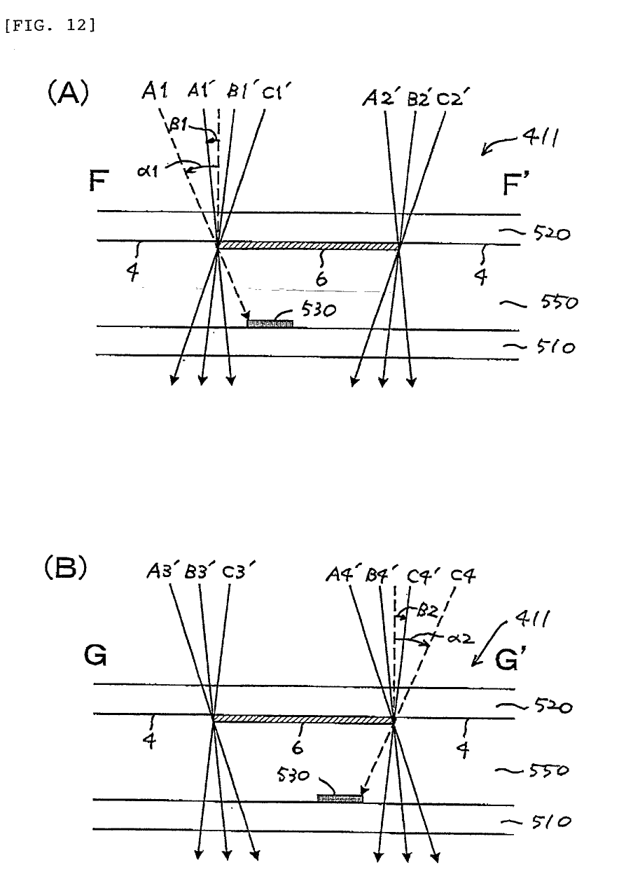

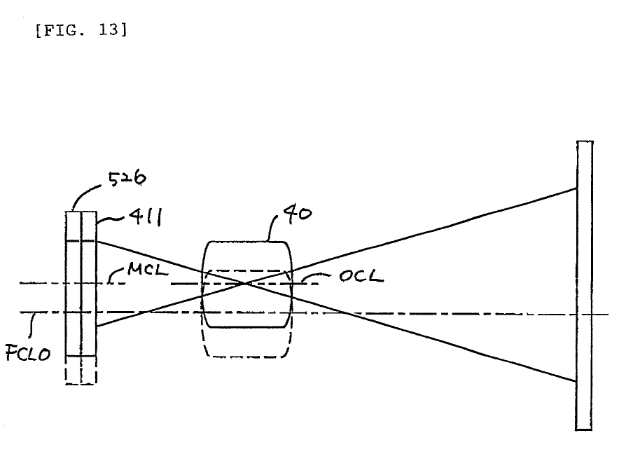

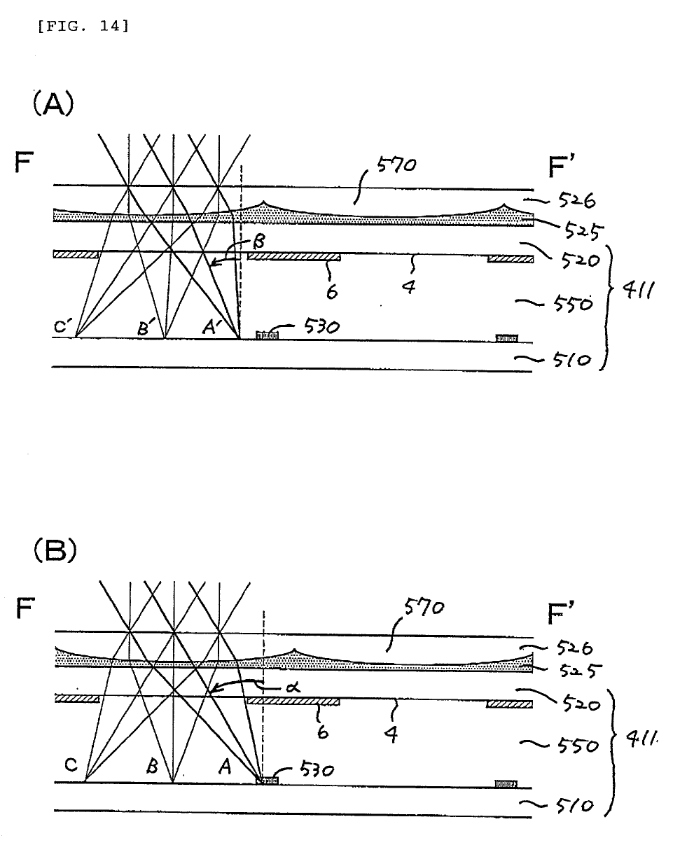

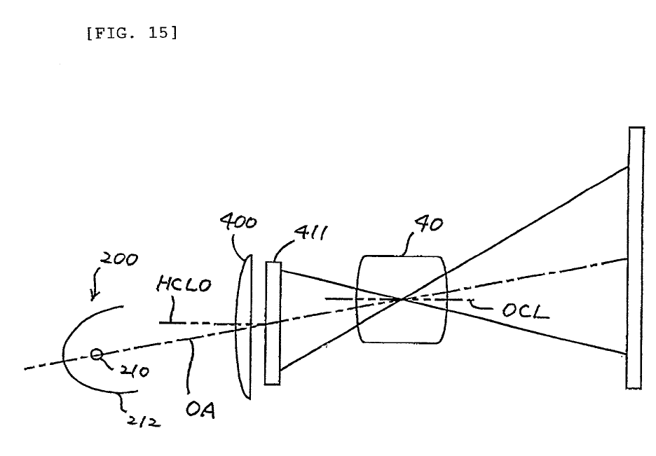

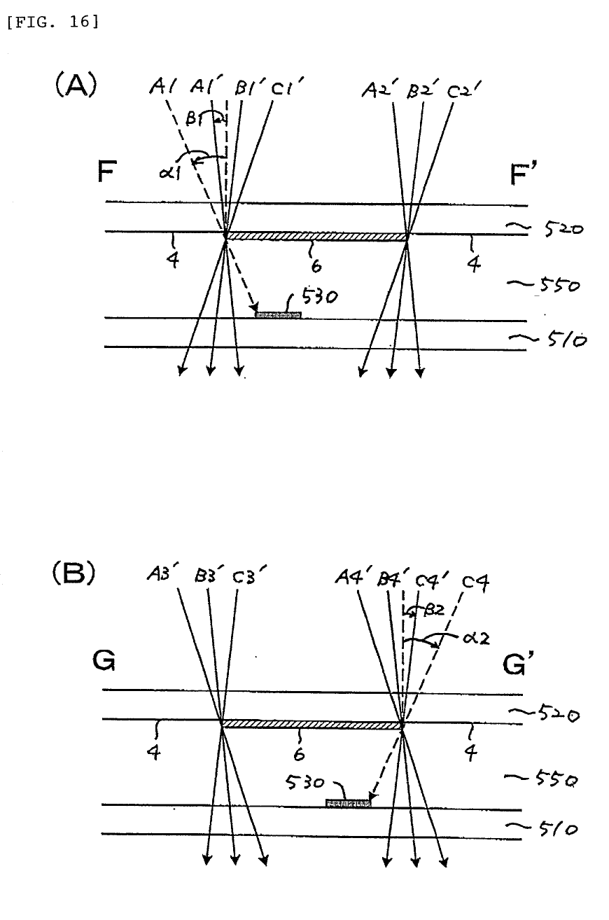

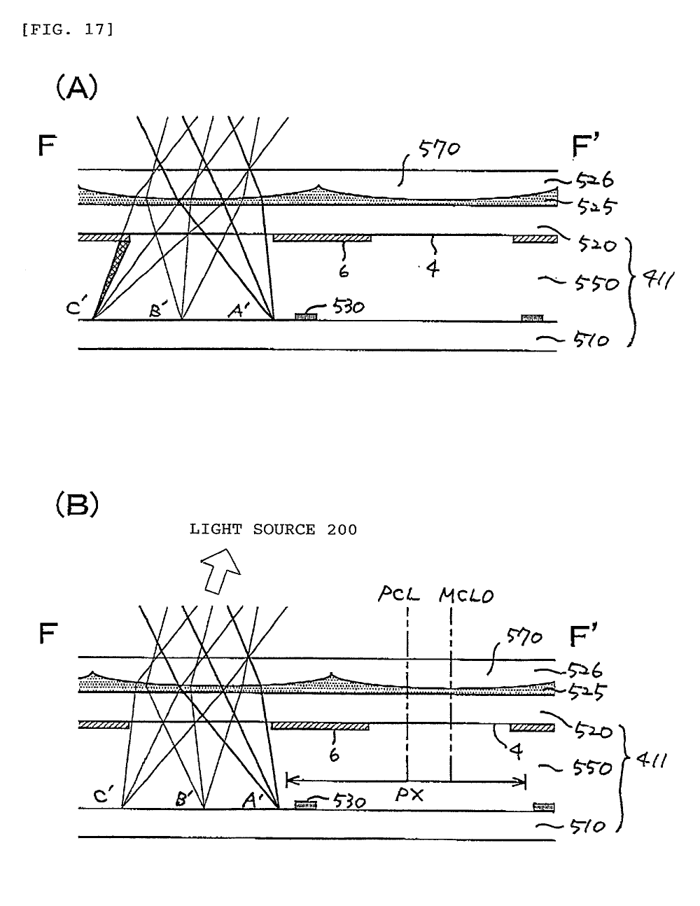

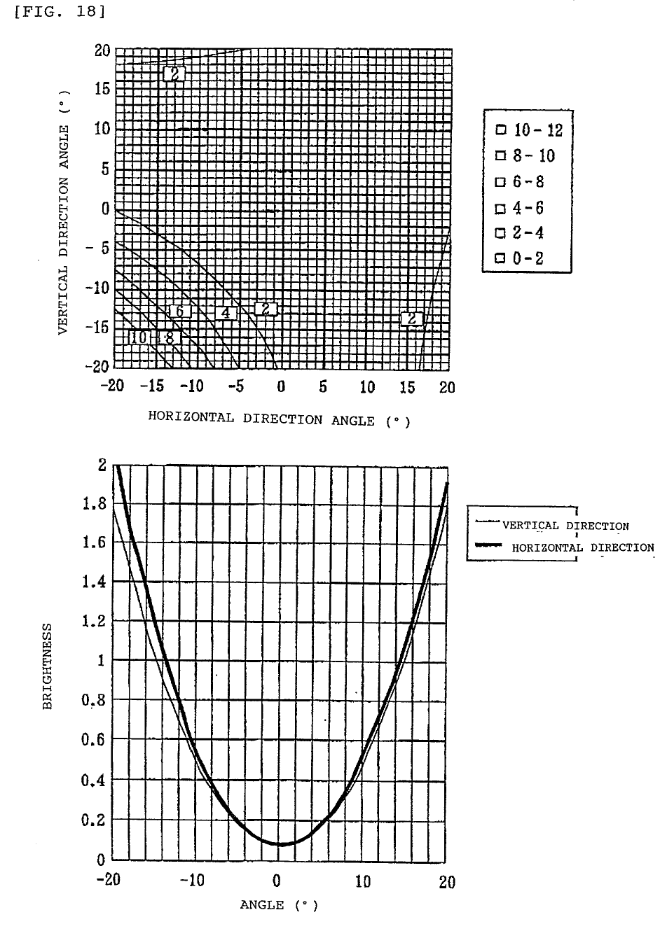

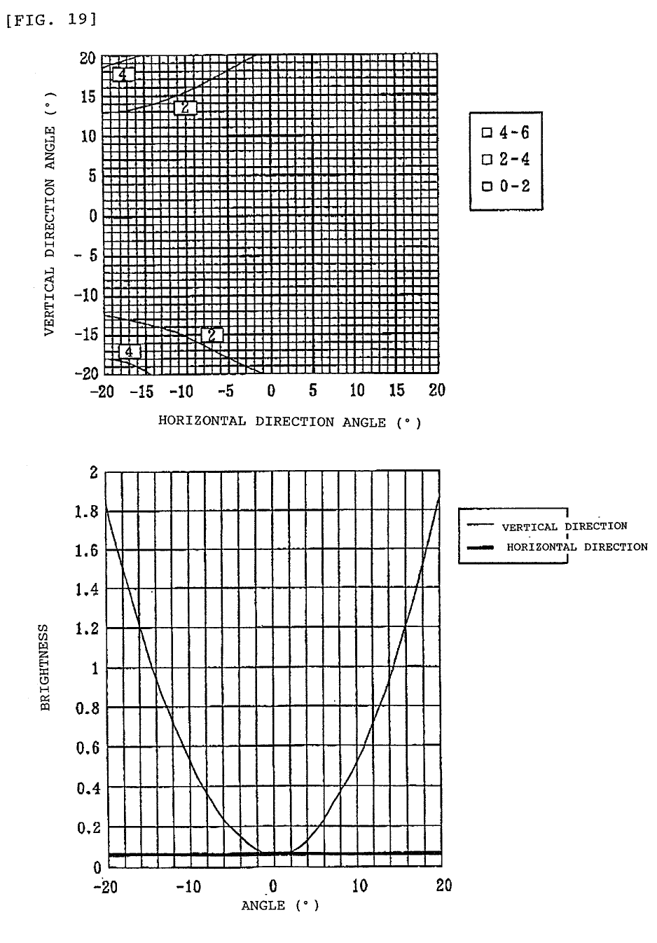

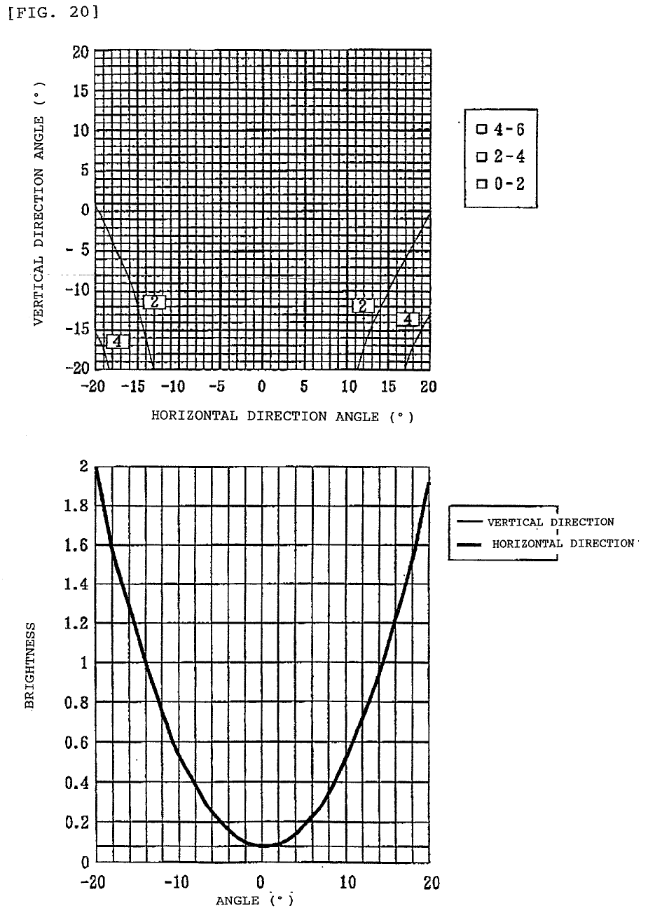

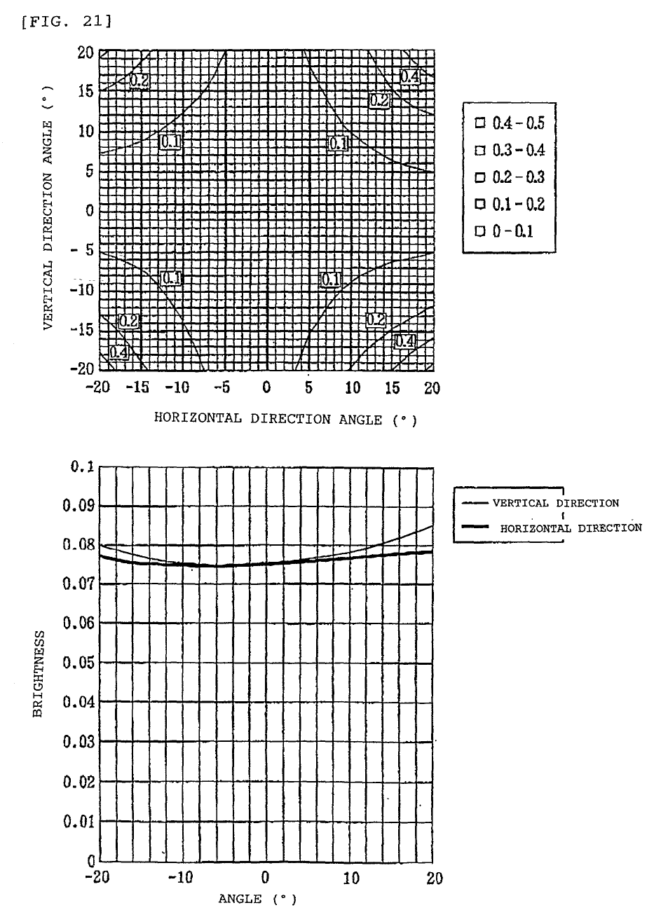

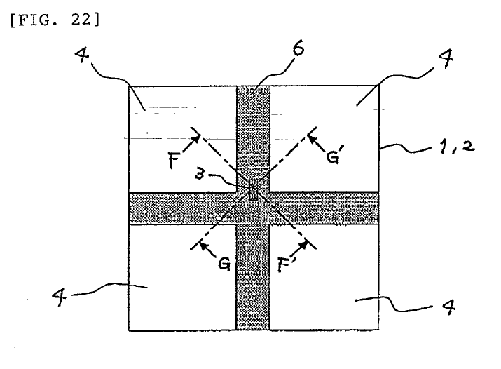

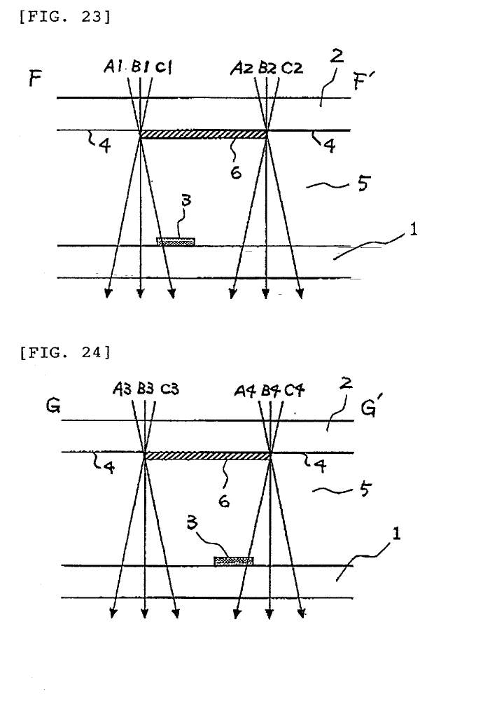

### REFERENCE NUMERALS

1: base substrate

2: counter substrate

3: drive element

4: open portion

5: liquid crystals

6: light-shielding mask

20: light source device

30: image forming optical system

40: projection lens

100: projector

200: light source

210: light source lamp

212: concave mirror

300: integrator optical system

320: first lens array

321: small lens

340: second lens array

341: small lens

350: light-shielding plate

351: light-shielding portion

352: open portion

360, 361, 362: polarization conversion element arrays

363: polarization beam splitter array

364: λ/2 retardation plate

365: light-transmissive member

366: polarization separation film

367: reflective film

368: polarization conversion element

370: superposition lens

380: color light separation optical system

382, 386: dichroic mirrors

384: reflective mirror

390: relay optical system

392: light-incident-side lens

394, 398: reflective mirrors

396: relay lens

400, 400R, 400G, 400B: field lenses

410, 410R, 410G, 410B: liquid crystal light valves

411, 411R, 411G, 411B: liquid crystal panels

412, 412R, 412G, 412B: light-incident-side polarizers

413, 413R, 413G, 413B: light-exiting-side polarizers

420: cross dichroic prism

51a: semiconductor layer

51a′: channel area

51b: lightly doped source area

51c: lightly doped drain area

51d: heavily doped source area

51e: heavily doped drain area

51f: first capacitive electrode

52: insulating thin film

53a: scanning line

53b: capacitive line

54: second interlayer insulating film

55: third contact hole

56a: data line

57: third interlayer insulating film

58a: first contact hole

59a: pixel electrode

501: data line drive circuit

502: external circuit connection terminal

504: scanning line drive circuit

505: wiring

506: upper and lower conductive materials

510: base substrate

511: first light-shielding film

512: underlying insulating film

516: alignment film

518a: contact hole

520: counter substrate

521: counter electrode

522: alignment film

523: second light-shielding film

525: adhesive

526: micro-lens array

527: micro-lens

530: thin-film transistor (TFT)

550: liquid crystals

552: sealant

553: third light-shielding film

570: storage capacitor

580: first barrier layer

581: first interlayer insulating film

585: second barrier layer

FCL: optical axis of field lens 400

FCL0: optical axis of incident light

OCL: optical axis of projection lens 40

MCL: center of micro-lens array

OA: optical axis of light source 200

HCL0: normal line of counter substrate 520

MCL0: optical axis of micro-lens 527

PX: pixel

PCL: center of pixel PX

A, A1 to A4, B, B1 to B4, C, C1 to C4: light

A′, A1′ to A4′, B′, B1′ to B4′, C′, C1′ to C4′: light

α, α1, α2, β, β1, β2: incident angles

G1, G2, . . . , Gm: scanning signals

S1, S2, . . . , Sn: image signals

1] A projector comprising:
a light source;
a liquid crystal device which modulates light emitted from the light source; and
a projection lens which projects the light modulated by the liquid crystal device;
wherein the liquid crystal device comprises a base substrate that has a plurality of pixel electrodes disposed in a matrix arrangement and drive elements each provided for corresponding one of the pixel electrodes and electrically connected thereto, a counter substrate provided with a light-shielding mask which covers at least a portion of the drive elements, and liquid crystals provided between the base substrate and the counter substrate; and
wherein the angle of light incident upon the liquid crystal device is restricted not to allow the light to strike the drive elements.

2] A projector according to claim 1, wherein a condenser lens is further provided at a light-incident side of the liquid crystal device, and wherein, by shifting a center axis of light incident upon the condenser lens and an optical axis of the condenser lens in parallel so that the incident angle of light that strikes the drive elements becomes small when the center axis of the light incident upon the condenser lens and the optical axis of the condenser lens coincide, the angle of the light incident upon the liquid crystal device is restricted.

3] A projector according to claim 2, wherein an optical axis of the projection lens is shifted parallel to the center axis of the light incident upon the condenser lens in the same direction as the optical axis of the condenser lens.

4] A projector according to claim 1, wherein a micro-lens array comprising a plurality of lenses corresponding to the pixel electrodes is further provided at a light-incident side of the base substrate, and wherein, by shifting a center axis of light incident upon the micro-lens array and a center of the micro-lens array so that the incident angle of light that strikes the drive elements becomes small when the center axis of the light incident upon the micro-lens array and the center of the micro-lens array coincide, the angle of the light incident upon the liquid crystal device is restricted.

5] A projector according to claim 4, wherein the micro-lens array is provided on the counter substrate.

6] A projector according to claim 4 or claim 5, wherein an optical axis of the projection lens is shifted parallel to the center axis of the light incident upon the micro-lens array in the same direction as the center of the micro-lens array.

7] A projector according to claim 1, wherein, by tilting an optical axis of the light source with respect to a normal line of the counter substrate so that the incident angle of light that strikes the drive elements becomes small when the normal line of the counter substrate and the optical axis of the light source are parallel to each other, the angle of the light incident upon the liquid crystal device is restricted.

8] A projector according to claim 7, wherein an optical axis of the projection lens is shifted parallel to the normal line of the counter substrate in the same direction as the optical axis of the light source.

9] A projector according to claim 7 or claim 8, wherein a micro-lens array comprising a plurality of lenses corresponding to the pixel electrodes is further provided at a light-incident side of the base substrate.

10] A projector according to claim 9, wherein optical axes of the plurality of lenses are shifted parallel to a center of a pixel of the liquid crystal device towards the light source.

11] A projector according to either claim 9 or claim 10, wherein the micro-lens array is provided on the counter substrate.

12] A projector according to any one of claims 1 to 11, wherein a center axis of the light incident upon the liquid crystal device coincides with a distinct-vision direction of the liquid crystal device.

13] A projector according to any one of claims 1 to 11, wherein a viewing angle compensating film which causes a center axis of the light incident upon the liquid crystal device and a distinct-vision direction of the liquid crystal device to coincide is further provided at the light-incident side of the liquid crystal device.

14] A projector according to any one of claims 1 to 11, wherein a viewing angle compensating film which causes a center axis of light emitted from the liquid crystal device and a distinct-vision direction of the liquid crystal device to coincide is further provided at a light-exiting side of the liquid crystal device.

15] A projector according to any one of claims 1 to 11, wherein viewing angle compensating films are further provided at the light-incident side and a light-exiting side of the liquid crystal device.

16] A projector according to any one of claims 1 to 15, wherein a scanning line and a data line crossing and situated above the scanning line on the base substrate are provided at the base substrate, and wherein the drive.
